(19) United States
(12) Patent Application Publication
(10) Pub. No.: US 2023/0349173 A1
(43) Pub. Date: Nov. 2, 2023

(54) APPARATUS AND METHOD FOR MANUFACTURING A SOLID, LOAD-BEARING CONSTRUCTION FROM A HARDENING BUILDING MATERIAL, AND RECESS FORMWORK SYSTEM

(71) Applicant: Hubertus Dietrich WINTER VON ADLERSFLÜGEL, Weilmünster (DE)

(72) Inventor: Hubertus Dietrich WINTER VON ADLERSFLÜGEL, Weilmünster (DE)

(21) Appl. No.: 18/219,760

(22) Filed: Jul. 10, 2023

Related U.S. Application Data
(63) Continuation of application No. PCT/EP2022/050202, filed on Jan. 6, 2022.

(30) Foreign Application Priority Data
Jan. 8, 2021 (DE) 10 2021 100 228.1

(51) Int. Cl. E04G 11/24; E04G 11/26; E04G 11/34; E04G 21/04

(52) U.S. Cl. CPC E04G 11/24; E04G 11/26; E04G 11/34; E04G 21/0427

(57) ABSTRACT

The disclosure relates to an apparatus (1) for applying a hardening building material against a formwork (2) for manufacturing a solid, load-bearing construction (3), for example a wall of a building, having at least one spray nozzle (4) for spraying the building material in a spraying direction (5), a manipulator (6) which guides the at least one spray nozzle (4) and provides the spraying direction (5), wherein the manipulator (6) is mounted on a movable carriage (7), wherein the formwork (2) is formed by a formwork panel (8) which can be moved together with the carriage (7) and is positioned relative to the spray nozzle (4) in the spraying direction (5) and is oriented substantially transversely to the spraying direction (5). The disclosure also relates to a recess formwork system (25), a reinforcement mat (46), a fastening element (51) and a method for manufacturing a solid, load-bearing construction (3), for example a wall of a building, from a hardening building material.

### RELATED APPLICATIONS

This application is a Continuation of PCT Patent Application No. PCT/EP2022/050202 having International filing date of Jan. 6, 2022, which claims the benefit of priority of Germany Patent Application No. 10 2021 100 228.1 filed on Jan. 8, 2021. The contents of the above applications are all incorporated by reference as if fully set forth herein in their entirety.

### FIELD AND BACKGROUND OF THE INVENTION

The disclosure relates to an apparatus for applying a hardening building material or a building material stable by compaction against a formwork for manufacturing a solid, load-bearing construction, for example a wall of a building, having at least one spray nozzle for spraying the building material in a spraying direction, a manipulator guiding the at least one spray nozzle and prescribing the spraying direction. The disclosure further relates to a recess formwork system and a method for producing a solid, load-bearing construction, for example a wall of a building, from a building material which hardens or is stable by compaction.

A device for applying a hardening building material against a formwork to produce a solid, load-bearing construction is known, for example, from US 991,814 A. Meanwhile, automatic manipulators for such devices are also known, via which the spray nozzle of the device for spraying the building material is automatically guided in a spraying direction.

Today, these devices are mainly used for the application of shotcrete. This is currently used mainly for the repair and reinforcement of concrete components, for terrain and rock consolidation, for temporary shoring at large construction sites and in tunnel construction, and for creating natural-like surfaces at recreational and sports climbing facilities.

The shotcrete process for example provides for that no or only one-sided formwork is required, and compaction after application of the concrete can be omitted, as very good adhesion is generally achieved. Sprayed concrete can thus be applied as a curing building material to produce a strong, load-bearing construction against a formwork or directly onto a wall to be reinforced. This is done by the dry spraying method or by the wet spraying method. In the dry spraying process, cement, aggregates and powdered admixtures are mixed together dry and fed into the concrete spraying machine and conveyed in a compressed air stream (thin stream conveying) through the pipe or hose line to the spraying nozzle. Only in the nozzle area is this dry mixture provided with the necessary water and, if necessary, liquid admixtures and accelerated to form a continuous jet. In the wet spraying process, on the other hand, cement, aggregate and water are mixed together and conveyed to a spray nozzle of the concrete spraying machine by means of a concrete pump (dense-phase conveying) or compressed air (thin-phase conveying).

Due to the necessity of applying the curing building material against a formwork or against a wall to be reinforced with the building material, the fields of application of such spraying methods are rather limited.

### SUMMARY OF THE INVENTION

The present disclosure relates for example to an apparatus for applying a hardening building material or a building material capable of load-bearing by compaction against a formwork for manufacturing a solid, load-bearing construction, for example a wall of a building, having at least one spray nozzle for spraying the building material in a spraying direction and a manipulator guiding the at least one spray nozzle and prescribing the spraying direction.

### BRIEF DESCRIPTION OF THE SEVERAL VIEWS OF THE DRAWINGS

FIG. 1 shows an apparatus according to the disclosure on a construction site,

FIG. 2 shows a detailed view of the apparatus,

FIG. 3 shows a side view of the apparatus,

FIG. 4 shows a detailed view of the apparatus from the side,

FIG. 5 shows a view of the carriage,

FIG. 6 shows a view of the formwork,

FIG. 7 shows another view of the apparatus at the construction site,

FIG. 8 shows another detailed view of the apparatus,

FIG. 9 shows a detailed view of the roll,

FIG. 10 shows a top view of the apparatus at the construction site,

FIG. 11 shows a detailed top view of the apparatus,

FIG. 12 shows a view of the rotating device,

FIG. 13 shows a top view of the rotating device,

FIG. 14 shows a side view of the rotating device,

FIG. 15 shows a sectional view through the rotating device,

FIG. 16 shows another sectional view through the rotating device,

FIG. 17 shows a view of a recess formwork system,

FIG. 18 shows a view of the spacers,

FIG. 19 shows a side view of the spacers,

FIG. 20 shows a top view of a reinforcement mat,

FIG. 21 shows a view of a fastening element,

FIG. 22 shows a side view of a fastening element,

FIG. 23 shows a side view of a reinforcement mat with fastening elements,

FIG. 24 shows a top view of a reinforcement mat with fastening elements

FIG. 25 shows an apparatus according to the disclosure on a construction site,

FIG. 26 shows a view of apparatus moved sideways,

FIG. 27 shows a further view of laterally moved apparatus,

FIG. 28 shows a top view of the apparatus,

FIG. 29 shows a detailed view of the final formwork,

FIG. 30 shows another detailed view of the final formwork,

FIG. 31 shows another detailed view of the final formwork,

FIG. 32 shows a view of the formwork panel,

FIG. 33 shows a side view of the formwork panel,

FIG. 34 shows a detailed side view of the formwork panel,

FIG. 35 shows a detailed view of the connecting channels,

FIG. 36 shows a detailed view of the supports,

FIG. 37 shows a view of the apparatus at the edge of the building,

FIG. 38 shows a further view of the apparatus at the edge of the building, and

FIG. 39 shows another view of the apparatus at the edge of the building.

### DESCRIPTION OF THE SPECIFIC EMBODIMENTS OF THE INVENTION

The present disclosure relates for example to an apparatus for applying a hardening building material or a building material capable of load-bearing by compaction against a formwork for manufacturing a solid, load-bearing construction, for example a wall of a building, having at least one spray nozzle for spraying the building material in a spraying direction and a manipulator guiding the at least one spray nozzle and prescribing the spraying direction, wherein the manipulator is mounted on a movable carriage, wherein the formwork is formed by a formwork panel which can be moved together with the carriage and is positioned relative to the spray nozzle in the spraying direction and is oriented substantially transversely to the spraying direction.

In that the manipulator is mounted on a movable carriage, the formwork being formed by a formwork panel which is movable together with the carriage and is positioned relative to the spray nozzle in the spraying direction and is aligned essentially transversely to the spraying direction, the formwork can be easily guided in the spraying direction in front of the spray nozzle held by the manipulator. Thus, via an automatically movable carriage on which an automatic manipulator is mounted, automatically hardening building material or building material that is stable by compaction can be applied against the formwork via the spray nozzle guided by the manipulator to manufacture a stable, load-bearing construction. The apparatus for applying the hardening or compaction-stable building material sprays the building material during application against the formwork in the spraying direction. This for example compacts the building material and makes it stable. In this way, clay without a hydraulic binder can also be used as a building material, since this building material already has sufficient load-bearing/stability capacity after compaction. The building material is for example sprayed against the formwork in an essentially horizontal direction. During spraying, the building material passes starting from the spray nozzle onto the formwork arranged in the trajectory of the building material. The essentially horizontally oriented spraying direction results in a slight deviation in height on the trajectory of the building material due to gravity. The formwork for example forms an application plane extending substantially orthogonally to the spraying direction, on which the building material is applied against the formwork. For this purpose, the formwork panel of the formwork is oriented essentially transverse to the spraying direction. This means that the formwork panel forms the application plane, which for example extends vertically and horizontally in front of the spray nozzle. With the formwork, which can be moved together with the carriage in the spraying direction in front of the spray nozzle held by the manipulator, a solid, load-bearing construction, for example a wall of a building, can be easily realized by spraying on the hardening building material, which is stable due to compaction. In this way, for example, it is very easy to produce a concrete or clay wall by spraying the building material against the formwork panel, which is guided by the carriage so that it can be moved in the spraying direction in front of the spray nozzle. The hardening building material is compacted against the formwork panel during spraying to form a solid, load-bearing construction.

Embodiments and further developments of the disclosure result from the dependent claims. It should be noted that the features listed individually in the claims can also be combined with one another in any desired and technologically useful manner and thus reveal further embodiments of the disclosure.

According to an embodiment, a spray nozzle feed device is provided which is adapted to effect the feed of the spray nozzle on the manipulator relative to the carriage. With an automatic spray nozzle feed device on the apparatus, it is very simple to enable automatic feed of the spray nozzle on the manipulator relative to the carriage. In the simplest case, the spray nozzle feed device allows translational movement of the spray nozzle on the manipulator to adjust the height of the spray nozzle relative to the subsoil. However, the spray nozzle feed device can also provide a translational movement of the spray nozzle on the manipulator to move the spray nozzle along the concrete wall to be manufactured without moving the carriage on the subsoil. In addition, the spray nozzle feed device can for example execute a translatory movement of the spray nozzle on the manipulator in the direction of the formwork.

An embodiment is one that provides a darby for drawing off the sprayed-on building material, which can be positioned relative to the carriage by means of an (automatic) darby feed device. The automatic darby feed device provides the ability to automatically position the darby relative to the carriage for this purpose. In the simplest case, the darby feed device provides a change in height and a translatory, for example horizontal, movement of the for example vertically oriented darby. This makes it very easy to automatically pull off the manufactured, solid, load-bearing construction, for example the wall of a building, so that this work step can be taken over by the apparatus. With the darby that can be automatically fed via the darby feed device, the surface of the construction to be manufactured can be easily drawn smooth.

An embodiment relates to the fact that a formwork feed device is provided which is designed to effect the feed of the formwork, for example of the formwork panel, relative to the carriage. With the formwork feed device, an automatic feed of the formwork, for example of the formwork panel, relative to the carriage can be effected very simply. In the simplest case, the formwork feed device enables a translatory movement of the formwork or the formwork panel in order to adjust the height of the entire formwork or the formwork panel relative to the subsoil. In addition, the formwork feed device can also for example be used to adjust the height of the entire formwork or formwork panel relative to the spray nozzles. In this way, it can be ensured that the formwork panel is guided in front of the spray nozzle held by the manipulator in the spraying direction, for example when the sprayer feed device changes the position of the spray nozzle relative to the carriage. Thus, the formwork feed device can be synchronized with the spray nozzle feed device in such a way that the formwork panel is always positioned relative to the spray nozzle in the spraying direction and is aligned substantially transversely to the spraying direction. Via the formwork feed device, the formwork can be lifted very easily for moving the carriage.

An embodiment provides a bracket jib connected to the carriage, which retains the formwork, for example the formwork panel, on the movable carriage. The formwork, for example the formwork panel, can be very easily moved directly together with the carriage by means of this bracket jib mounted on the carriage. Via the bracket jib, it is also very easy to synchronize the movement of the spray nozzle and the formwork panel, since both elements are connected to the carriage. This makes it for example easy to move the formwork panel together with the carriage and to position it relative to the spray nozzle in the spraying direction. The formwork panel or the entire formwork can be held via the bracket jib for moving the carriage when the formwork feed device lifts the entire formwork or the formwork panel from the subsoil, for example.

In one embodiment, the bracket jib extends over the construction to be fabricated, thereby positioning the formwork panel and the spray nozzles on opposite sides of the construction. For example, in this case, the bracket jib simply overhangs the construction to be manufactured so that the formwork panel is simply positioned relative to the spray nozzle in the direction of spraying and is oriented substantially transverse to the direction of spraying.

An embodiment provides that the bracket jib is movable on two bridge girders via a trolley and has a motor slewing ring. With this arrangement, the formwork at the end of a manufactured wall can be moved until the center of rotation of the motor slewing ring is outside the manufactured wall surface. By rotating the motor slewing ring, the formwork is turned in the direction of the plane on which the new wall to be built is to be created. As a result of several movement steps that the carriage then travels and the movement of the formwork on the bridge girders, the apparatus is at a right angle to the wall that has already been constructed and, in accordance with the procedures that will be described in more detail, can construct the next wall section in such a way that a building edge is created at a right angle to the wall that has already been constructed.

The carriage can be guided on a rail system to travel on a subsoil. Guiding the carriage on a rail system makes it for example easy to control and define the traversing motion of the automatically traversable carriage. The rail system can also be replaced by autonomous driving of the carriage. The apparatus for example moves autonomously along programmed travel paths, which can be located on floor slabs at any height.

An embodiment provides that the formwork panel is protected by a protective foil, wherein an unwinding device is provided which is designed to unwind the protective foil from a roll and to guide it over the formwork panel. Protecting the formwork panel by the protective foil provides a simple means of preventing the formwork panel from being contaminated with splashes of the building material applied against the formwork. Here, the hardening building material is simply applied against the formwork panel while remaining separated from the formwork panel by the protective foil so that the formwork panel can continue to be moved along with the carriage, and remains positioned relative to the spray nozzle in the spraying direction and oriented substantially transverse to the spraying direction. For example, the protective foil remains on the construction to be manufactured and can be used for post-treatment of the hardening building material. Once the foil has been removed, the surface of the construction is produced to such an extent that no further work steps are required. In order to reduce the initial rebound of shotcrete during the first application on the protective foil, concrete mortar is for example applied first.

According to an embodiment, the unwinding device is designed to unwind the protective foil from the roll against the direction of travel of the carriage. For example, the circumferential speed during unwinding of the roll is equal in amount to the travel speed of the carriage. The unwinding device can be used to ensure that sufficient protective foil is unwound as the carriage moves along the construction to be manufactured. Thus, an unwound section of foil against which the building material has been applied remains on the construction section where the hardening building material or the building material capable of load-bearing by compaction has been applied to the foil section against the formwork panel even when the carriage is moved along the construction to be manufactured. The protective foil may be made of plastic (polymeric material) and may be suitable for post-treatment of concrete. The protective foil may comprise a foil web, wherein an edge portion along the foil web is self-adhesive, the edge portion of the foil web being adapted to be bonded to further foil webs of the protective foil.

An embodiment provides that the formwork panel has a vacuum clamping surface which is designed to clamp the protective foil plane on the formwork panel. Via this vacuum clamping surface, the protective foil can be clamped for example easily and securely in a smooth state on the formwork panel. By clamping the protective foil on the vacuum clamping surface, wrinkles can be avoided. The protective foil, which is firmly bonded to the formwork by vacuum, creates a stable surface to which the hardening building material or building material that is load-bearing due to compaction adheres immediately, without increased bounce, furthermore, this firm bond ensures that even a thin layer of building material adheres to the formwork. This is for example important when graded components are to be produced by spraying on several layers of building materials with different properties. Finally, the firm bond between the formwork and the protective foil ensures that the manufactured wall element, which at this stage has not yet set and thus consists of a non-stable suspension of high viscosity, cannot fall over. Until the manufactured wall section is supported, it is held in place by adhesion to the protective foil, which forms a firm bond by vacuum with the formwork and thus with the overall construction. An embodiment provides that the vacuum clamping surface is formed by a perforated plate with connecting channels behind it. The connecting channels for example connect a plurality of holes in the perforated plate to a vacuum source. The perforated plate allows the protective foil to adhere securely to the vacuum clamping surface without deformation. When the protective foil is clamped, the connections for the vacuum lines suck it in via the vacuum generated by the vacuum source. For this purpose, the connecting channels arranged behind the perforated plate transfer the generated vacuum to several holes, which open into the connecting channels, in the perforated plate. The hole size of the perforated plate is selected so that the protective foil is sucked in without deformation.

A separating device adapted to separate an upper portion of the protective foil passed over the formwork panel from a lower portion may be provided, and a winding device adapted to wind up the separated upper portion may be provided.

With this separating device, an upper part of the formwork panel can be protected with an upper partial section of the protective foil that does not remain on the construction for post-treatment of the hardening building material. On the other hand, with the separation of the upper portion of the protective foil and the lower portion of the protective foil, the lower portion of the protective foil can be used for post-treatment of the hardening building material, so that the lower portion remains on the construction. The upper section, on the other hand, is simply wound up automatically by the winding device after it has protected the formwork panel in an upper area during spraying of the building material.

An embodiment provides a sensor device which is designed to generate a stop signal by which the spraying of the building material is stopped if the sensor device detects a first limit of a recess formwork system when the spray nozzle is moving, and/or which is designed to generate a start signal by which the spraying of the building material is started and/or continued if the sensor device detects a second limit of the recess formwork system when the spray nozzle is moving along the construction to be manufactured. Via this sensor device, an automatic spraying of building material optimized for the use of recess formwork systems (e.g. for the production of doors or windows in a wall) can be made possible very easily. With the sensor-controlled interruption of the spraying, building material can be prevented from reaching the inside of the recess formwork system used. In addition, it can be ensured that the building material is sprayed exactly up to the recess formwork system.

An embodiment provides that the apparatus comprises at least two spray nozzles, wherein the first spray nozzle is designed to spray a first building material and the second spray nozzle is designed to spray a second building material different from the first building material. With multiple tips, it is very easy to switch between multiple building materials during spraying. For example, a building material with a waterproofing effect can be used for exterior areas of the construction, while a building material with a higher thermal insulation property can also be used for an interior area of the construction. In this way, it is very easy to realize a layered structure of the construction with core insulation. With the two spray nozzles, it is possible to quickly change the spray nozzle used, so that it is possible to quickly switch between different building materials during spraying.

A building material distribution equipment with a rotating device can be provided on the apparatus, the rotating device having at least two torus-shaped rotor elements aligned parallel to one another, the rotor elements each being guided on a circular disc-shaped stator element so as to be rotatable about a common axis of rotation of the rotating device, each rotor element being fluidically connected to the associated stator element, the rotor elements each being connected to an outgoing building material distribution line and the stator elements each being connected to an incoming building material supply line. With this rotating device, at least two building material lines can be rotated relative to each other without twisting lines. A further through line can be guided through the stator element by the rotating device, this through line having a rotary coupling which enables the through line to be rotated about a line axis of this through line. When the building material lines are rotated relative to each other, the torus-shaped rotor elements on the circular disc-shaped stator elements rotate about the common axis of rotation of the rotating device so that the two building material lines are prevented from twisting around each other when they are rotated relative to each other at the ends of the building material supply lines or at the ends of the outgoing building material distribution lines. This can happen when the movable carriage of the apparatus is guided in several self-contained laps during travel along the construction to be manufactured with two building material lines connected.

A first spray nozzle can be supplied with material for spraying via a first building material supply line and a first building material distribution line, while a second spray nozzle is supplied with material for spraying via a second building material supply line and a second building material distribution line. With the separate supply of the spraying nozzles via the separate building material lines, different building material can be supplied quickly and easily to the respective spraying nozzle from respectively different concrete pumps or concrete spraying machines via the building material distribution lines and the building material supply lines. In this case, the building material can first be fed to the spray nozzle via the building material supply line, the rotating device and then via the outgoing building material distribution line. In order to enable a quick change between the spray nozzles used and the building materials sprayed on with them, the building material supply lines and the building material distribution lines leaving the rotating device form separate building material lines for the respective connected spray nozzle, which are fed by different concrete pumps or concrete spraying machines.

The hardening building material can be a shotcrete. Shotcrete is a versatile usable and already proven building material. However, other hardening building materials or materials that can be made load-bearing by compaction can also be used to produce the solid, load-bearing construction with the proposed apparatus. Thus, clay, which becomes compacted clay via compaction, or plaster could also be applied with the apparatus.

An embodiment provides that the formwork has at least one edge formwork, which is designed to be arranged laterally flush with the formwork panel at an angle to the formwork panel. Using the edge formwork, edges of the construction to be manufactured can be produced very easily. For this purpose, the edge formwork of the formwork is simply arranged laterally flush with the formwork panel at a defined angle to the formwork panel. When the building material is sprayed onto the formwork panel, the edge formwork then forms a lateral finish to the construction to be manufactured at the angle formed between the formwork panel and the edge formwork. The lateral finish can be used to form building edges by arranging the edge formwork flush with the side of the formwork panel before the building material is sprayed on.

According to an embodiment, it is provided that the formwork has at least one final formwork which is designed to be arranged flush on an upper side of the formwork panel at an angle to the formwork panel. With the final formwork on the upper side of the formwork panel, an upper finish of the construction to be manufactured can be realized. The final formwork can be used, for example, to produce a support surface for floor slabs in the construction to be built. For this purpose, the end formwork forms an upper closure under which the construction to be manufactured is created by spraying building material onto the formwork panel. When the building material is sprayed onto the formwork panel, the end formwork then forms an upper finish to the construction to be manufactured at the angle formed between the formwork panel and the final formwork.

An embodiment is one in which the final formwork can be pivoted relative to the formwork panel by means of a motor. By pivoting the final formwork to an obtuse angle by means of a drive motor, a gap is created between the formwork panel and the final formwork. The protective foil is inserted into this gap. By means of a clamping rubber, which is located on the edge of the final formwork facing the formwork panel, the protective foil can be fixed when the end formwork is pivoted to a right angle to the formwork panel. Above all, however, the pivoting of the final formwork can be used to achieve easy release of the formwork from the manufactured construction and release of the protective foil from its fixation. An embodiment provides that the final formwork has at least one slot for receiving a connection reinforcement. This allows the connection reinforcement of the construction to be manufactured to simply protrude from the final formwork when the formwork is positioned. This makes it for example easy to produce upper connections for force-locking connections of floor slabs, for example. The slot for receiving connection reinforcement is for example dimensioned in such a way that the connection reinforcement can protrude through the slot, but building material sprayed onto the formwork panel remains as far as possible under the final formwork and thus forms a smooth upper surface of the construction to be manufactured, from which the connection reinforcement protrudes.

Furthermore, it is an object of the disclosure to provide a recess formwork system for the production of recesses for doors and/or windows, comprising a plurality of formwork boards forming a door and/or window formwork, wherein the formwork boards have a back side facing the recess and a contact side, wherein the contact side forms the frame inner side of the produced recess, wherein at least one formwork board on the contact side is fastened to at least one structural steel bar of the recess formwork system via spacers of the recess formwork system, said structural steel bar being adapted to be fastened to a subsoil for positioning the door and/or window formwork. This recess formwork system provides a simple means of positioning and fixing a formwork for producing recesses for doors and/or windows in the construction to be manufactured even before the hardening building material is sprayed on. The recess formwork system can be easily positioned by means of structural steel bars held at a distance from the contact side of the formwork boards by spacers. For positioning the door and/or window formwork, the structural steel bars of the recess formwork system can be easily fixed to a floor slab, so that the recess formwork system can be easily positioned on the floor slab by spraying on hardening building material before the construction is built, and freestanding on the floor slab is subsequently surrounded by the stable, load-bearing construction. The structural steel bars of the recess formwork system remain in the hardening building material after completion of the stable load-bearing construction, further reinforcing the area along the formed recess. After the building material has hardened, the spacers can be easily separated from the formwork boards to reuse the remaining recess formwork system.

For example, a reinforcement mat having a plurality of intersecting bars may be used. The intersecting bars of the reinforcement mat can be connected to one another at crossing points to form a mat level, wherein a plurality of vertical bars of the bars are in each case aligned vertically longitudinally and parallel to one another and parallel to the mat level, and a plurality of horizontal bars of the bars are in each case arranged horizontally longitudinally and parallel to one another and parallel to the mat level and intersecting the vertical bars, wherein in each case at least two vertical bars run grouped together and offset from one another orthogonally to the mat level and on both sides of the horizontal bars. With the double-grouped vertical bars running on both sides of the horizontal bars, a for example rigid reinforcing mat is provided which can stand upright independently. With the offset of the vertical bars, it can be achieved that building material sprayed onto the reinforcement mat completely surrounds the bars without forming gaps between the building material and the bars.

For example, a fastening element can be used for fastening at crossing points of crossing bars. This fastening element has a head and a shank, the shank having a cross-slot recess which has undercuts in the direction of the shank in order to clamp the fastening element in the cross-slot recess at the undercuts when intersecting bars are received in the direction of the shank. The shaft length between the undercuts and the head is selected to ensure sufficient concrete cover between the received bars and the head. This fastening element can be used to attach protective foil to a reinforcement mat. By clamping the fastening element, it can be easily attached to a reinforcement mat. Thus, if necessary, a protective foil can also be positioned and fastened independently of a formwork in order to spray a solid, load-bearing construction of hardening building material against the fastened protective foil, ideally supported by the formwork panel of the apparatus according to the disclosure.

The head of the fastening element can have a self-adhesive fastening surface on the back side opposite the shaft. A protective foil can be very easily adhered to the fastening element via the fastening surface. This means that the protective foil can also be positioned and fastened independently of a formwork in order to spray a solid, load-bearing construction of hardening building material against the fastened protective foil.

Furthermore, it is an object of the disclosure to provide a method for producing a solid, load-bearing construction, for example a wall of a building, from a building material which hardens or is stable by compaction, comprising the following steps:
applying the hardening building material against a formwork, for example using an apparatus already and described in more detail below, wherein a manipulator guides at least one spray nozzle for spraying on the building material and prescribes a spraying direction of the spray nozzle,
moving a carriage, on which the manipulator is mounted, in a direction of travel along the construction to be manufactured on a subsoil, and
moving the formwork formed by a formwork panel together with the carriage, the formwork panel being positioned relative to the spray nozzle in the spraying direction and being oriented substantially transversely to the spraying direction.

This process makes it very easy to produce a solid, load-bearing construction, for example a wall of a building, from a building material that is hardening or stable due to compaction. For this purpose, the building material is applied along the construction to be manufactured with a spray nozzle against the formwork, which is moved together with the carriage so that the formwork panel is positioned relative to the spray nozzle in the spraying direction and is aligned essentially transversely to the spraying direction. As the building material is applied, it completes a trajectory from the spray nozzle to the formwork positioned in the trajectory of the building material. The for example substantially horizontally oriented spraying direction results in a slight deviation in height along the trajectory of the building material due to gravity. The formwork panel for example forms an application plane extending substantially orthogonally to the spraying direction, on which the building material is applied against the formwork. For this purpose, the formwork panel of the formwork is oriented substantially transversely to the spraying direction, so that the formwork panel forming the application plane for example extends vertically and horizontally and spaced in front of the spray nozzle. The formwork can simply be guided in the spraying direction in front of the spray nozzle held by the manipulator. Thus, via the spray nozzle guided by the manipulator, automatically hardening building material can be applied against the formwork to produce the solid, load-bearing construction. The spray nozzle can be automatically guided along the construction to be manufactured via the automatically movable carriage on which an automatic manipulator is mounted. The formwork is moved together with the carriage in order to remain aligned in the spraying direction in front of the spray nozzle held by the manipulator. In this way, the solid, load-bearing construction, for example a wall of a building, can be easily manufactured with a hardening building material by means of lateral spraying. This makes it very easy, for example, to produce a concrete wall with shotcrete or a wall of compacted clay by spraying the building material against the formwork panel guided in front of the spray nozzle.

When the carriage is being moved, a protective foil, for example a protective foil as described above and in more detail below, can also be unwound automatically from a roll in front of the formwork by an unwinding device to protect the formwork. Thus, in an embodiment of the method, the formwork panel is protected by a protective foil, with the hardening building material or the building material that is load-bearing due to compaction being applied to the formwork panel against the protective foil.

An embodiment of the method provides that the protective foil is tensioned on the formwork panel of the apparatus before application from a vacuum tensioning surface. Tensioning the protective foil on a vacuum tensioning surface of the formwork panel offers the possibility that the protective foil can be arranged very smoothly on the formwork panel. The tensioning of the protective foil on the vacuum tensioning surface prevents wrinkles, so that very smooth surfaces of the construction to be manufactured can be realized on the formwork panel protected with the foil. The protective foil, which is for example wrinkle-free fitting, is securely supported on the formwork panel so that damage caused by the sprayed-on building material can be easily prevented. To tension the protective foil, it is first fixed between the formwork panel and the final formwork in a clamping device provided for this purpose. The formwork is then positioned in terms of height and alignment. A vacuum is then generated via a vacuum source, which sucks the protective foil onto the vacuum clamping surface of the formwork panel and fixes it in place. After completion of the section of the construction to be manufactured, the vacuum fixing the protective foil on the vacuum clamping surface of the formwork foil can be easily released, so that after opening the fixation between the formwork panel and the final formwork, the protective foil is released from the clamping device from the formwork panel. In this way, the formwork can be easily removed from the manufactured construction and, for example, the protective foil remains on the manufactured construction for post-treatment. A new section of the protective foil can then be easily clamped onto the vacuum clamping surface of the formwork panel before the next section of the construction is fabricated.

According to an embodiment of the method, it is provided that the carriage of the device is moved step by step along the construction to be manufactured, whereby between the steps of moving the carriage, the construction to be manufactured is produced in sections by adjoining sections by applying the hardening building material or the building material that is stable by compaction against the formwork of the apparatus. With the step-by-step movement of the carriage on the subsoil, the hardening building material can very easily be applied successively in sections against the same formwork. Thus, the formwork serves as a sliding formwork, which can be moved step by step by moving the carriage. By moving the carriage, adjacent sections of the construction to be manufactured can be formed one after the other with the sliding formwork, which moves step by step in the direction of travel along the construction to be manufactured. After positioning the formwork by moving the carriage, the hardening or compaction-stable building material can be applied against the formwork section by section.

An embodiment of the method provides that the formwork is lifted from the subsoil by a formwork feed device of the carriage traversing device. On the one hand, this process serves to ensure that the final formwork is located above the connecting reinforcement before it is moved. After moving to the next wall section to be manufactured, the lifting of the formwork is used to create a gap between the ground slab and the formwork. The excess length of protective foil is now blown into this gap by means of compressed air, and the foil wraps around the lower edge of the formwork. To apply the hardening building material, the formwork is set down on the subsoil. With the formwork lifted by the formwork feed device, the formwork can be easily positioned by moving the carriage to produce the next construction section. Once the location for the next construction section has been reached by moving the carriage, the formwork can be set back down on the subsoil by the formwork feed device so that the formwork seals to the subsoil. Then, by applying the hardening construction material against the formwork, the construction to be manufactured can be formed on the subsoil. Lifting the formwork provides sufficient ground clearance so that the formwork is not damaged when the carriage is moved.

According to an embodiment of the method, it is provided that for the production of edges of the construction to be manufactured, at least one edge formwork of the formwork is arranged laterally flush with the formwork panel at an angle to the formwork panel. The arrangement of the edge formwork enables edges to be easily produced on the construction to be manufactured. For this purpose, the edge formwork of the formwork can simply be arranged laterally flush with the formwork panel at a defined angle to the formwork panel. When the hardening building material is sprayed on, the angle formed between the formwork panel and the edge formwork forms a lateral finish to the construction to be manufactured. This makes it easy to shape building edges by arranging the edge formwork flush with the side of the formwork panel before spraying on the building material. An embodiment of the method is that the edge formwork is arranged at an acute angle to the formwork panel. This makes it for example easy to produce right-angled edges on the construction to be manufactured.

An embodiment of the method provides that for the production of edges of the construction to be manufactured, the apparatus places the formwork panel flush against a previously produced wall so that a right-angled adjoining wall section of the construction to be manufactured can be produced. This makes it very easy to produce right-angled edges on the construction to be manufactured.

According to an embodiment of the method, it is provided that the carriage of the apparatus for producing a stable, load-bearing construction, for example a wall of a building, is placed on a ground slab and/or floor slab and is moved on this subsoil during the production of the stable, load-bearing construction. This means that the apparatus can be used at all possible floor heights. Multi-storey buildings, for example with more than three storeys, can be easily constructed with the apparatus, since the apparatus is set down on the floor slab or the topmost finished storey ceiling for the construction of the walls of the building.

Before the hardening building material is applied to the formwork, at least one reinforcement, for example comprising a reinforcement mat as described in more detail above and below, can be attached to the subsoil, wherein the at least one reinforcement is located between the at least one spray nozzle and the formwork for manufacturing the construction when the hardening building material is applied. With the reinforcement attached to the subsoil, the reinforcement can be free in space to allow the building material to be applied around the reinforcement. If the reinforcement is located between the spray nozzle and the formwork when the building material is applied, it can be ensured that the reinforcement reinforces and stabilizes the solid, load-bearing construction made of the hardening building material from the inside. After the reinforcement mat has been fastened to the floor slab, fastening elements, for example fastening elements as described before and in more detail below, can be fastened to crossing points of crossing bars of the reinforcement mat, wherein a protective foil, for example a protective foil as described before and in more detail below, can be fastened to the fastening elements before the hardening building material is applied.

During the method, the carriage can be guided along the construction to be manufactured in several self-contained laps, so that when the hardening building material is applied, the construction is built up layer by layer with each lap. The solid, load-bearing construction can be manufactured continuously by layering the hardening building material in laps. When applied in closed laps, the layer of building material already applied in the previous lap can cure to such an extent that it is load-bearing enough for the application of the next layer. The building material is sprayed layer by layer in an essentially horizontally aligned spraying direction against the essentially vertically aligned formwork. However, the building material can also be applied against a first layer of the construction to be manufactured, if it is intended to produce a multi-layer construction. In this way, for example, a building material with a waterproofing effect can be used for external areas of the construction, while a building material with a higher thermal insulation property can be used for an internal area of the construction. The method according to the disclosure thus also enables layer-by-layer (additive) manufacturing, whereby construction takes place from the outside (from the side of the formwork) to the inside (towards the spray nozzle). In this case, the formwork formed by the formwork panel serves as formwork only when the outermost layer is applied. The other layers are then sprayed onto the layers already present, i.e. layer by layer from the outside inwards.

Before the hardening or compaction-stable building material is applied against the formwork, a recess formwork system, for example a recess formwork system as described in more detail above and below, can also be attached to a floor slab to produce recesses for doors and/or windows in the solid, load-bearing construction made of the hardening or compaction-stable building material.

### DETAILED DESCRIPTION OF THE DRAWINGS

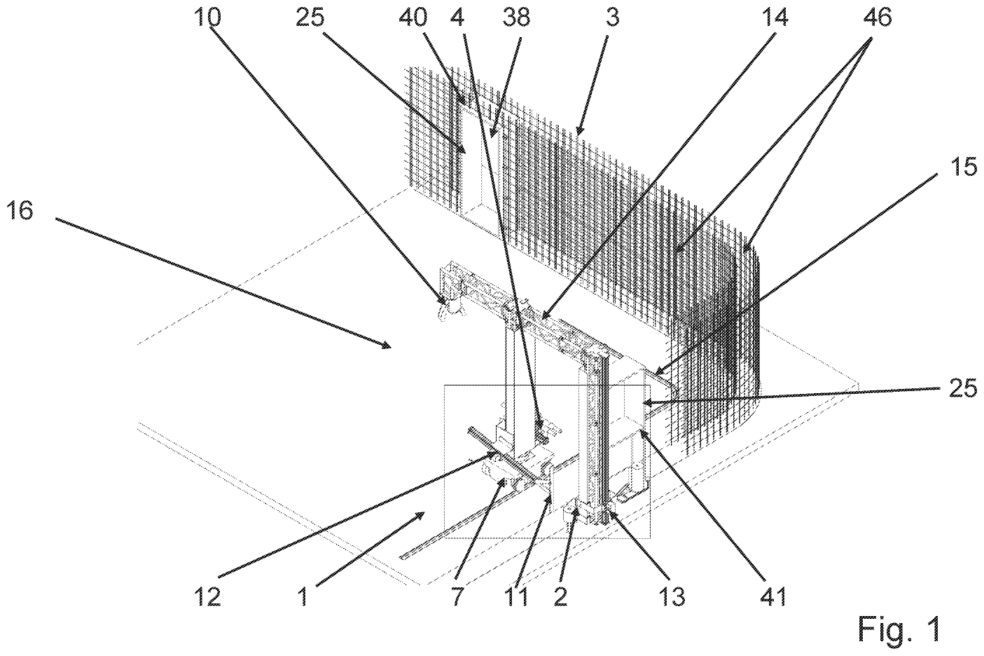

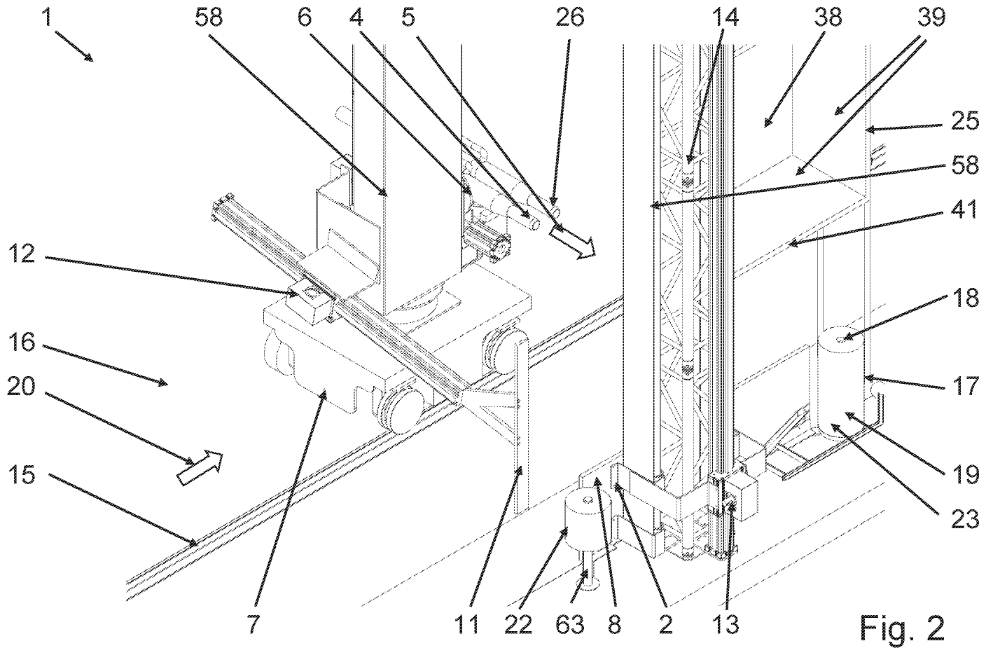

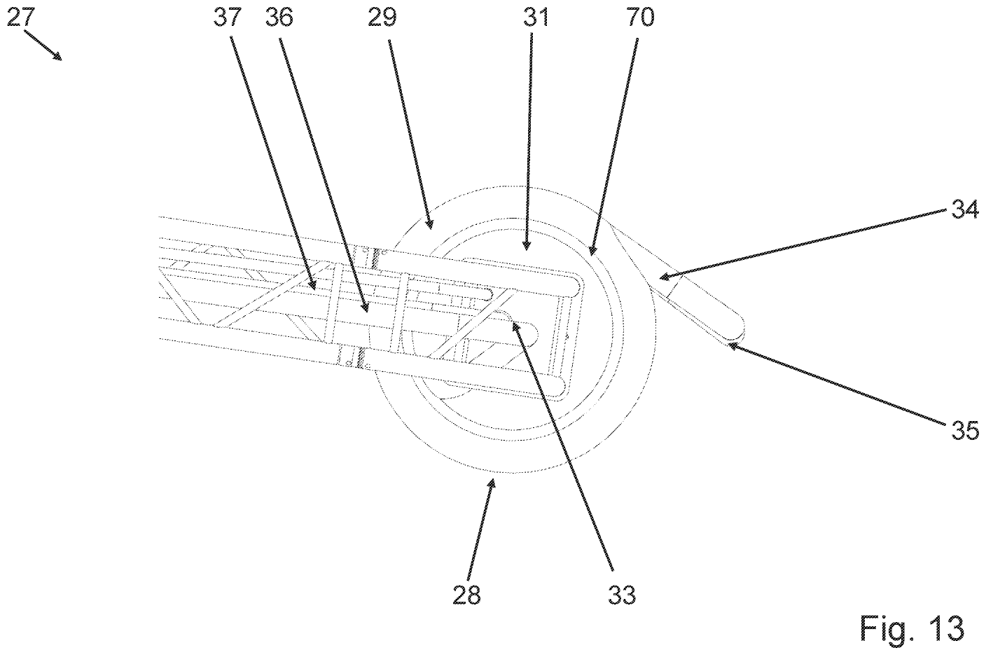

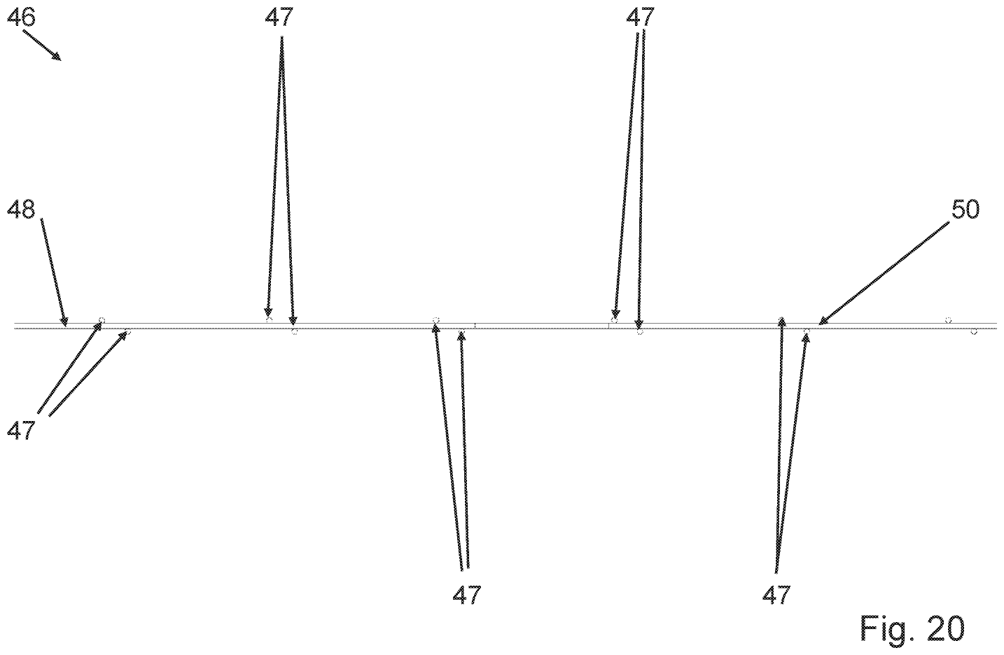

In FIG. 1, designated by the reference sign 1, an apparatus according to the disclosure is shown on a construction site. The apparatus 1 is used for applying a hardening building material against a formwork 2 to produce a wall of a building on a ground slab 16. The apparatus 1 can also be used for the manufacture of other solid, load-bearing constructions. Reinforcement mats 46 comprising a plurality of intersecting bars 47, 48, which are interconnected at crossing points 49 to form a mat plane 50 (FIG. 20), are placed on the ground slab 16 to reinforce the wall to be manufactured. The apparatus has a movable carriage 7, which is for example guided along the erected reinforcement mats 46 on a rail system 15 for manufacturing the load-bearing, stable construction from the hardening building material during application of the building material. To produce recesses 38 for doors and/or windows, recess formwork systems 25 described in more detail later are arranged in the mat plane 50 (FIG. 20) of the reinforcement mats 46. The apparatus 1 shown here has two spray nozzles 4, 26 for spraying the building material in a spraying direction 5 and a manipulator 6 guiding the spray nozzles 4, 26 and prescribing the spraying direction 5. This manipulator 6 is mounted on the movable carriage 7. Also mounted on this carriage 7 is a bracket jib 14, which holds a formwork panel 8 on the movable carriage 7. The bracket jib 14 extends in a portal-like manner over the construction 3 to be manufactured, so that the formwork panel 8 and the spray nozzles 4, 26 are positioned on opposite sides of the construction 3. For example, on the side facing away from the formwork panel 8, the bracket jib 14 has a receptacle 10 for building material distribution lines 34, 35 (FIG. 13) and a counterweight. A formwork 2 is formed by the formwork panel 8, which can be moved together with the carriage 7 and is positioned relative to the spray nozzles 4, 26 in the spraying direction 5 and is oriented substantially transversely to the spraying direction 5. This allows the formwork 2 to be easily guided in the spraying direction 5 in front of the spray nozzles 4, 26 held by the manipulator 6. Thus, via an automatically movable carriage 7 on which an automatic manipulator 6 is mounted, automatically hardening construction material can be applied against the formwork 2 via the spray nozzles 4, 26 guided by the manipulator 6 to produce a solid, load-bearing construction. To produce a solid, load-bearing construction 3, for example a wall of a building, from a hardening building material, the hardening building material is simply applied against the formwork 2, the manipulator 6 guiding the spray nozzles 4, 26 for spraying on the building material and prescribing a spraying direction 5 of the spray nozzles 4, 26. In this process, the carriage 7 can be moved, namely in a direction of travel 20 along the construction 3 to be manufactured on a subsoil 16, such as a ground slab. At the same time, the formwork 2 formed by the formwork panel 8 can also be moved together with the carriage 7 so that the formwork panel 8 remains positioned relative to the spray nozzle 4 in the spraying direction 5 and is oriented substantially transversely to the spraying direction 5. For example, the reinforcement mat 46 is attached to the subsoil 16 prior to the application of the hardening construction material to the formwork 2 and is located between the spray nozzles 4, 26 and the formwork 2 during the manufacture of the construction 3 by the application of the hardening construction material. For example, the carriage 7 is guided along the construction 3 to be manufactured in a plurality of self-contained laps during travel, the illustration shown here showing only a partial section of the lap. During the application of the hardening building material, the construction 3 is built up layer by layer with each lap. In FIG. 1, a section is marked which is shown in FIG. 2.

FIG. 2 shows an enlarged detailed view of the apparatus according to FIG. 1. In this enlarged view, it can be seen that the apparatus has a darby 11 which is used to draw off the sprayed-on building material. For example, the darby 11 can be positioned relative to the carriage 7 by means of an automatic darby feed device 12. The automatic darby feed device 12 enables a change in height and a translatory, substantially horizontal movement of the vertically aligned darby 11. A formwork feed device 13 is provided on the bracket jib 14, which is designed to feed the formwork panel 8 relative to the carriage 7. For example, the formwork feed device 13 is formed by a linear drive alternatively by a cable pull with stepper motor. In the case shown here, the formwork feed device 13 serves to position the formwork panel 8 vertically, so that the height of the formwork panel 8 can be changed by the formwork feed device 13 via a vertical, translatory movement of the formwork 2 along the bracket jib 14 and can be adapted to the height of the spray nozzles 4, 26. To protect against dust and ricochets, covers 58 are attached to each of the cross members of the bracket jib 14. The apparatus 1 can be used to manufacture walls with reinforcement in any number of layers and layer thicknesses with different materials. Thus, first an outer shell with concrete in the required exposure class and minimum thickness, in the next layer insulating concrete, then the supporting shell and finally also an interior plaster can be applied to the walls to be produced.

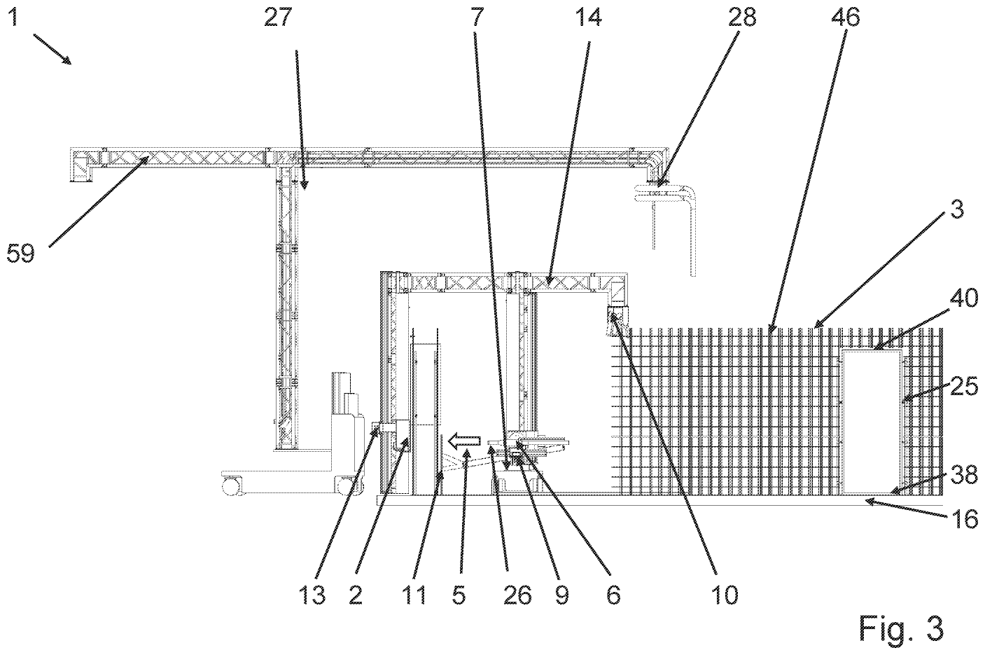

In FIG. 3, which shows a side view of the apparatus 1 according to the previous figures, it can be seen that a spray nozzle feed device 9 is also arranged on the bracket jib 14, which serves to adjust the spray nozzle 4 on the manipulator 6 relative to the carriage 7. Thus, via the spray nozzle feed device 9, the height of the spray nozzles 4, 26 can be changed by a vertical, translatory movement of the manipulator 6 on the bracket jib 14. Thus, as the hardening construction material is applied, the height of the spralap nozzles 4, 26 can be increased with each lap to build up the construction 3 in laps and layers. To better see the construction 3, the erected reinforcement mat 46 is shown interrupted. FIG. 3 also allows a view of a building material distribution equipment 27 of the apparatus 1. This building material distribution equipment 27 has a distribution pole 59 mounted on a carriage 7 and is used to feed the spray nozzles 4, 26 with building material starting from concrete spraying machines on the construction site. A rotating device 28 is arranged on the building material distribution equipment 27, via which building material distribution lines 34, 35 and building material supply lines 36, 37 are connected for supplying the spray nozzles 4, 26 with building material. The rotating device 28, described in more detail later, makes it possible to supply the spray nozzles 4, 26 without interruptions and without twisting the material lines 34, 35, 36, 37 when the construction 3 to be manufactured is traveled around in laps by the carriage 7.

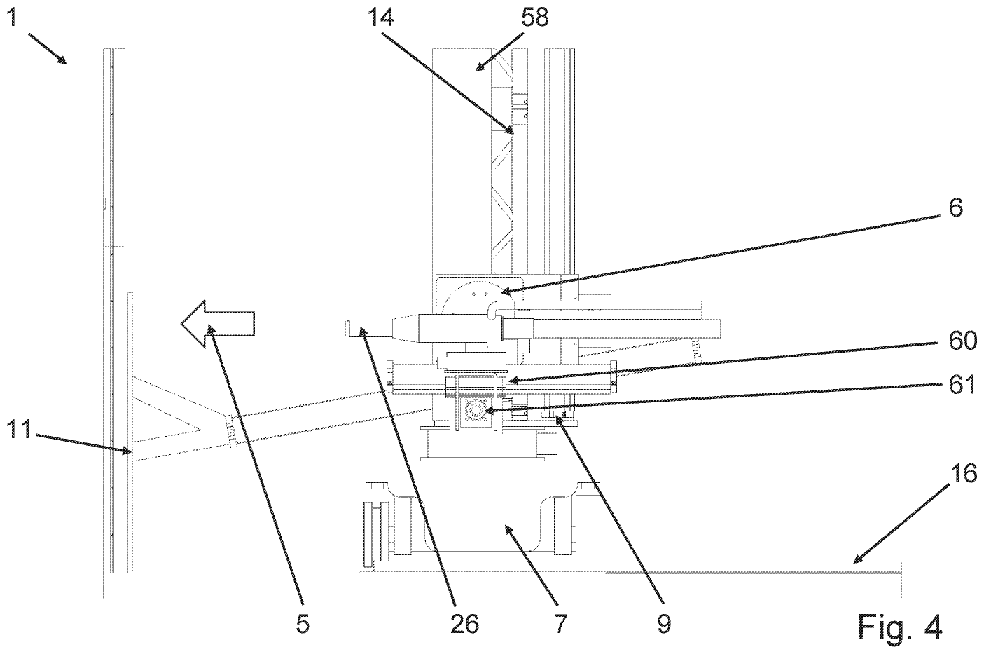

FIG. 4 shows a detail view of the apparatus 1 according to FIG. 3 from the side. In this representation, it can be clearly seen that the darby 11 is slightly angled at the darby feed device 12, but still has a vertical extension over which the surfaces of the construction 3 to be manufactured can be smoothly drawn off as the carriage 7 travels along the construction 3. It also provides a closer view of the spray nozzle feed device 9, which allows the spray nozzles 4 on the manipulator 6 to be fed relative to the carriage 7. In addition to a change in the height of the spray nozzles 4, 26, the spray nozzles 4, 26 can also be positioned in the direction of the construction 3 to be manufactured via the spray nozzle feed device 9, for example via a linear drive 60. A circulating movement of the spray nozzles 4, 26 is also possible. The linear drive 60 ensures the required distance of the spray nozzles 4, 26 from the wall surface as the wall thickness increases during the spraying process. The manipulator 6 can be used, for example, to change the inclination of the spray nozzles 4, 26, in order, for example, to enable uniform distribution during application of the building material and to avoid spray shadows. This can be achieved by uniformly pivoting the spray nozzles 4, 26 up and down when applying the building material via the automatic manipulator 6. For this purpose, the manipulator 6 has a first rotary head 61 which moves the spray nozzles in a vertical direction. In the illustration, it can also be seen that the wheels of the carriage 7 facing the construction 3 to be manufactured are guided in the rail system 15 in order to guide the carriage 7 during travel in the direction of travel 20 along the construction 3 to be manufactured.

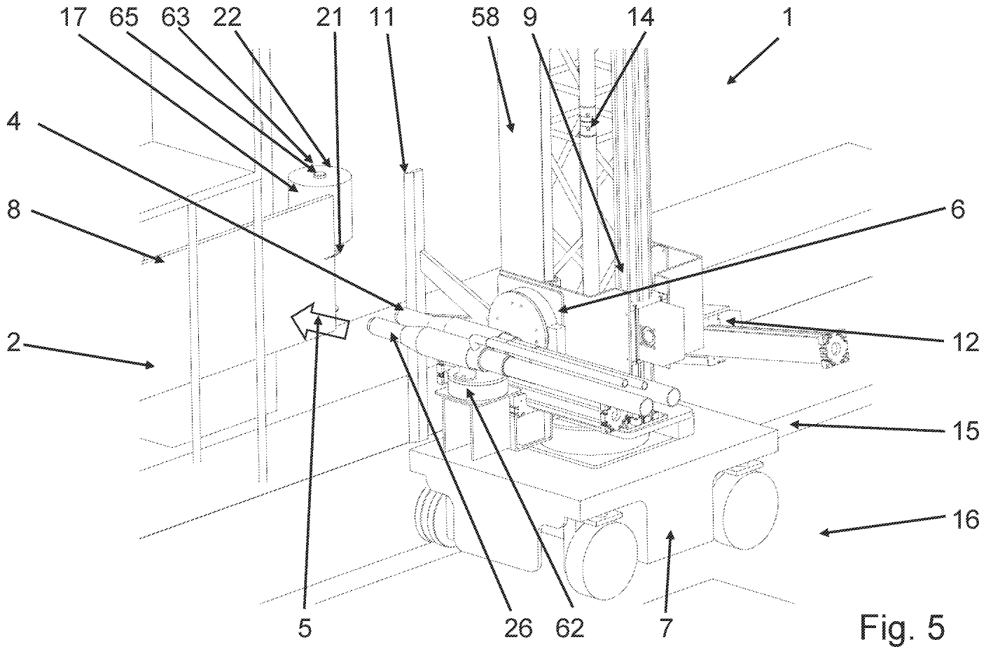

This can also be seen in FIG. 5, which is another view of the apparatus 1 according to the previous figures. In this illustration, it can also be seen that the manipulator 6 also allows the spray nozzles 4, 26 to swivel laterally. This means that the spray nozzles 4, 26 can also be pivoted back and forth uniformly in the direction of travel 20 when the building material is applied via the automatic manipulator 6, in order to enable uniform distribution of the building material. For this purpose, the manipulator 6 has a second rotary head 62 which swivels the spray nozzles 4, 26 in a horizontal direction. Both rotary heads 61, 62 of the manipulator 6 have the effect that a circulating movement of the spray nozzles 4, 26 is also possible and thus no spray shadow is created behind the reinforcement 46 and, moreover, the axis of the building material jet emerging from the spray nozzles 4, 26 is always kept at an optimum angle to the surface during the spraying process. It can also be seen that the darby feed device 12 allows the height of the darby 11 to be changed by vertical displacement along the bracket jib 14. In addition, the entire bracket jib 14 mounted on the carriage 7 can be rotated relative to the carriage 7 to align the spray nozzles 4, 26 together with the formwork 2 relative to the carriage 7. By means of the two spray nozzles 4, 26, a first building material can be sprayed on by means of the first spray nozzle 4, and a second building material different from the first building material can be sprayed on by means of the second spray nozzle 26. FIG. 5 also shows a separating device 21, which will be described in more detail below.

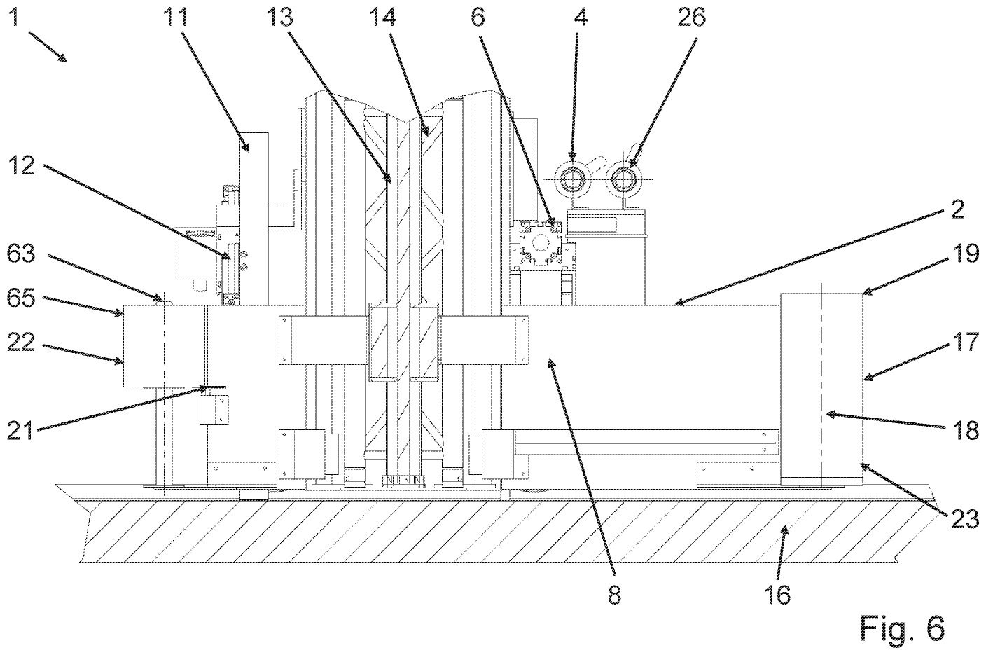

FIG. 6 shows a back view of the formwork 2. This illustration shows an unwinding device 18 which is designed to unwind a protective foil 17 from a roll 19 and guide it over the formwork panel 8. In this way, the formwork panel 8 is protected from the sprayed-on building material by the protective foil 17 sliding over the formwork panel 8. The unwinding device 18 unwinds the protective foil 17 from the roll 19 against the direction of travel 20 of the carriage 7, at a circumferential speed which is equal in amount to the speed of travel of the carriage 7. On the piece of construction 3 produced by the respective spraying operation, the unwound protective foil 17 remains on the construction 3 to be manufactured as the carriage 7 moves. The formwork panel 8 and the protective foil 17 are wider than the spray jet applied by the spraying nozzles 4, 26 during the respective operation. The application thickness of the material decreases from the core of the spray jet outwards. To ensure a load-bearing minimum thickness of the applied building material, an upper section 22 of the protective foil 17 on which there is applied material below the minimum thickness is cut off. For this purpose, the aforementioned separating device 21 is provided, which is designed to separate the upper section 22 of the protective foil 17 guided over the formwork panel 8 from a lower section 23. The separated upper section 22 is wound up via a rewinder 63. The upper part of the formwork panel 8 is protected with the upper section 22 of the protective foil 17, which, however, does not remain on the construction for post-treatment of the hardening building material. The upper section 22, after protecting the formwork panel 8 in an upper portion during spraying of the building material, is simply automatically wound up by the rewinder 63. By separating the upper section 22 of the protective foil 17 from the lower section 23 of the protective foil 17, the lower section 23 of the protective foil 17 can be used for post-treatment of the hardening building material so that the lower section 22 remains on the construction 3. Furthermore, it can be seen in FIG. 6 that the formwork 2 is guided on the support system 14 above the subsoil, the support system 14 for example being supported by the subsoil only via the carriage 7.

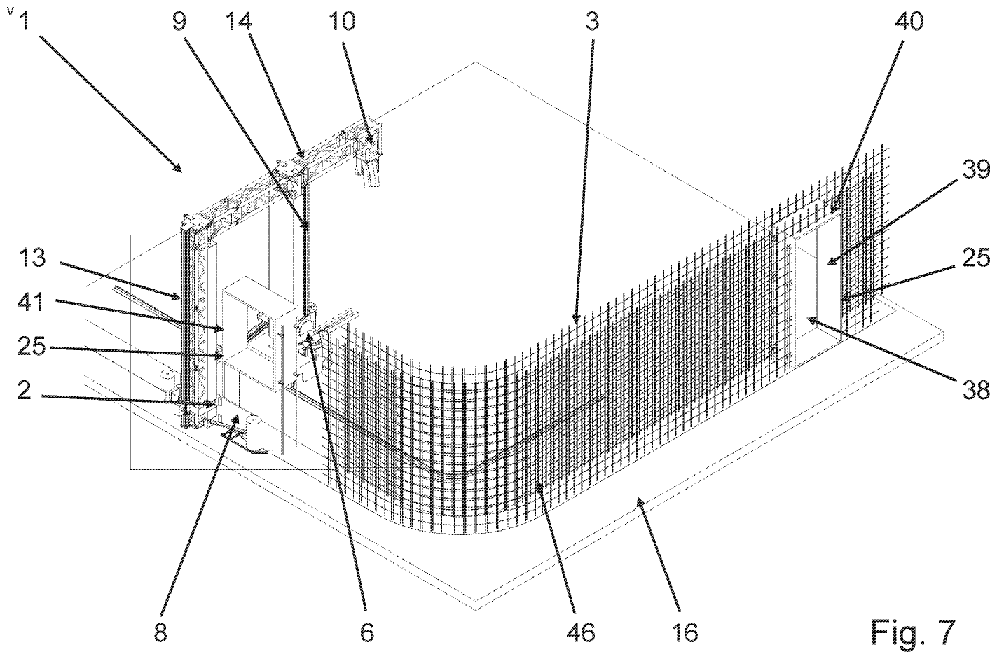

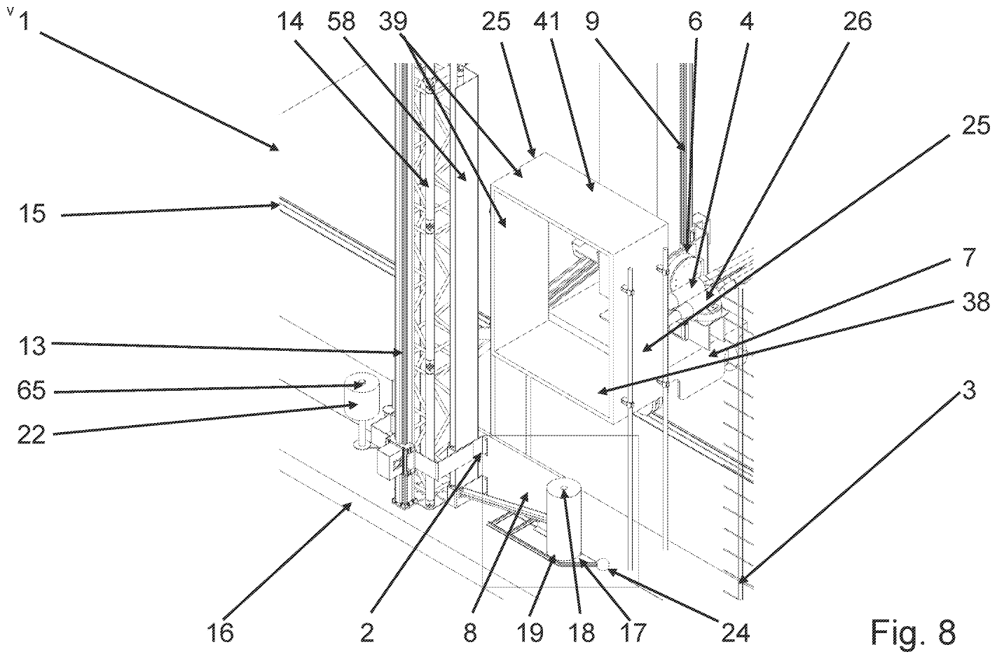

FIG. 7 shows another view of the apparatus 1 on the construction site, the perspective differing from the view in FIG. 1. In this representation, the erected reinforcement mats 46 are shown interrupted to allow a better view of the apparatus 1. In FIG. 7, a section is marked which is shown enlarged in FIG. 8.

FIG. 8 shows a further detailed view of the apparatus 1 according to FIG. 7. In this representation, the sensor device 24 of the apparatus 1 can be seen. The sensor device 24 is designed to generate a stop signal by means of which the spraying of the building material is stopped if the sensor device 24 detects a first limit of a recess formwork system 25 when the carriage 7 moves in the direction of travel 20 along the construction 3 to be manufactured. The sensor device 24 is located so far ahead of the spray nozzles 4, 26 in the direction of travel 20 that, when the carriage 7 moves at a predetermined speed of travel, the spraying of the building material stops in in time before the spray nozzles 4, 26 would inject the building material to be sprayed into the recess of the recess formwork system 25. Thus, the detection of the first limit is the trigger to interrupt the delivery of the hardening building material to the spray nozzles 4, 26 in order to stop the application of the building material in time before reaching the recess when the carriage continues to travel in the direction of travel. In addition, the sensor device can also be used to generate a start signal by which the spraying of the building material is started and/or continued, provided that the sensor device 24 detects a second limit of the recess formwork system 25 when the carriage moves in the direction of travel 20 along the construction 3 to be manufactured. This can ensure that the building material is again conveyed behind the recess 38 in time to be applied again via the spray nozzles 4, 26 in the direction of travel 20 behind the recess formwork system 26.

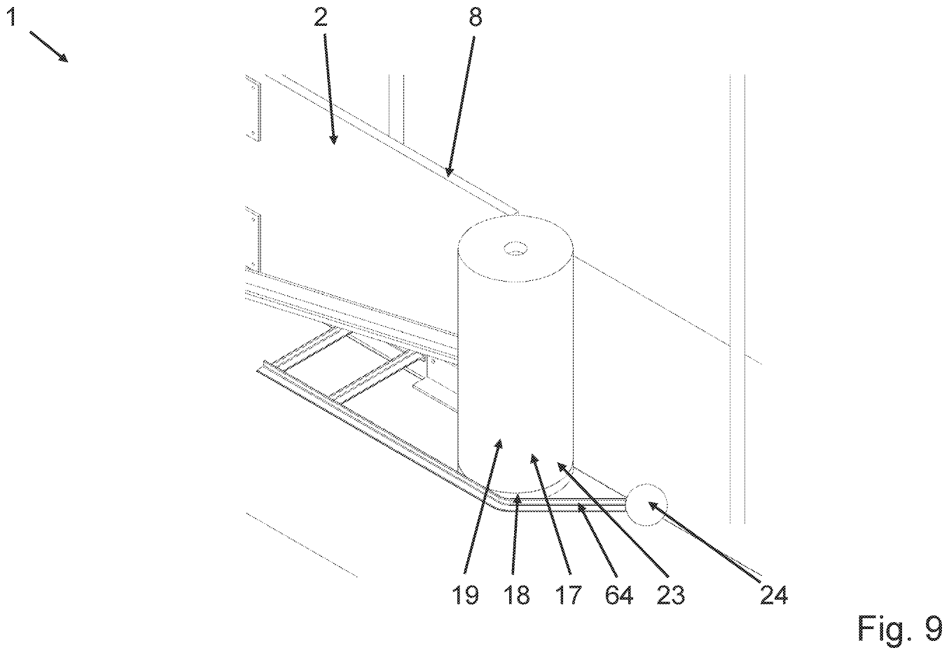

FIG. 9 shows another detailed view of the roll 19, which is unrolled over the formwork 2 by the unwinding device 18 in the direction of travel 20 in front of the formwork panel 8. As can be seen, the sensor device 24 is arranged via a sensor carrier 64 at a distance from the formwork 2 in front of the formwork panel 8 in the direction of travel 20 as far as the carriage 7 covers at a predetermined speed in terms of distance along the construction to be manufactured in the time in which the lines 34, 35, 36, 37 between a concrete spraying machine and the spraying nozzles 4, 26 are emptied or filled with building material. In addition, the limits of the recess formwork system 25 can thereby be detected in time when the carriage 7 is moved in the direction of travel 20.

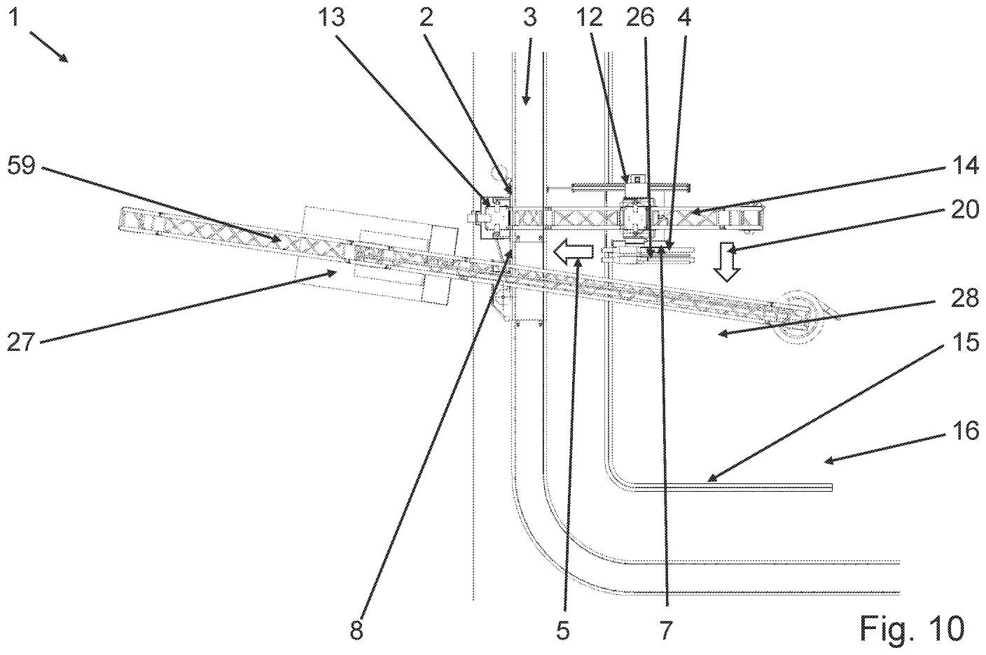

In the illustration according to FIG. 10, the apparatus 1 according to the previous figures is shown from a bird's eye view. The rail system 15 is arranged at a distance from the erected reinforcement mats 46 in order to guide the carriage 7 in the direction of travel 20 along the construction 3 to be manufactured. The rail system 15 is for example mounted parallel to the reinforcement 46, and this for example has corresponding bends at the edges of the building in each case. For example, the carriage 7 is guided in several self-contained laps during travel along the construction 3 to be manufactured, the illustration shown here showing only a partial section of the lap. The rotating device 28 on the building material distribution equipment 27 is arranged above the construction site within such a lap in order to guide the building material distribution lines (shown interrupted) between the rotating device 28 and the spray nozzles 4, 26 on the carriage 7. In this illustration, it can also be clearly seen that the bracket jib 14 extends over the construction 3 to be built and thus positions the formwork panel 8 and spray nozzles 4 on opposite sides of the construction 3.

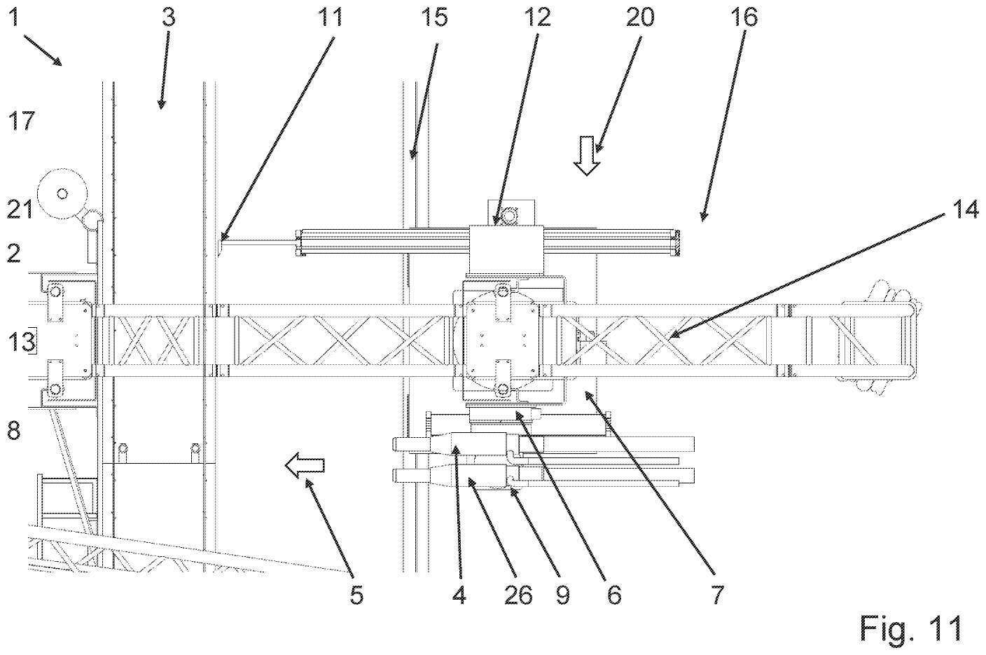

This can be seen even better in the detailed view according to FIG. 11 for the top view of the apparatus in FIG. 10. Furthermore, it can be seen in FIG. 11 that the darby 11 is formed by an angled float, which is guided along the construction 3 to be manufactured via the darby feed device 12 in the direction of travel 20 of the carriage 7. The erection of, for example, a concrete wall with the apparatus 1 proceeds in sections. First, concrete mortar is applied through a spray nozzle 4 and shotcrete through another spray nozzle 26. These building materials impinge on the formwork panel 8, which is covered with protective foil 17. In the width of the spray jet of the spray nozzles 4, 26, the protective foil 17 remains on the back of the sprayed concrete wall and is used for post-treatment of the concrete. The upper section 22 of the protective foil 17, which is located above the spray jet of the spray nozzles 4, 26, is cut off by a rotating knife of the separating device 21 and rolled up by the rewinder 63 onto a second roll 65, which has a corresponding drive. The carriage 7 travels around the inside of the building until it reaches the starting point again. Here, the spray nozzles 4, 26 and the formwork panel 8 are continuously raised until they have reached the diameter of the spray jet during one revolution inside the building. The protective foil 17 is bonded to the protective foil of the last rotation by the adhesive strip. This creates a continuous foil parallel to the wall, which is used for post-treatment of the concrete.

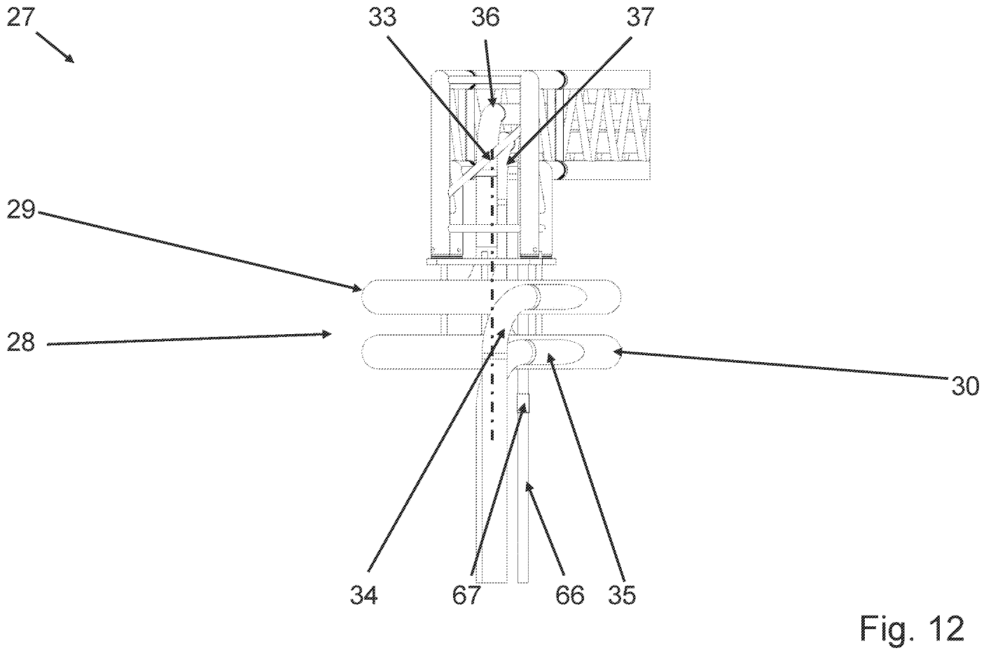

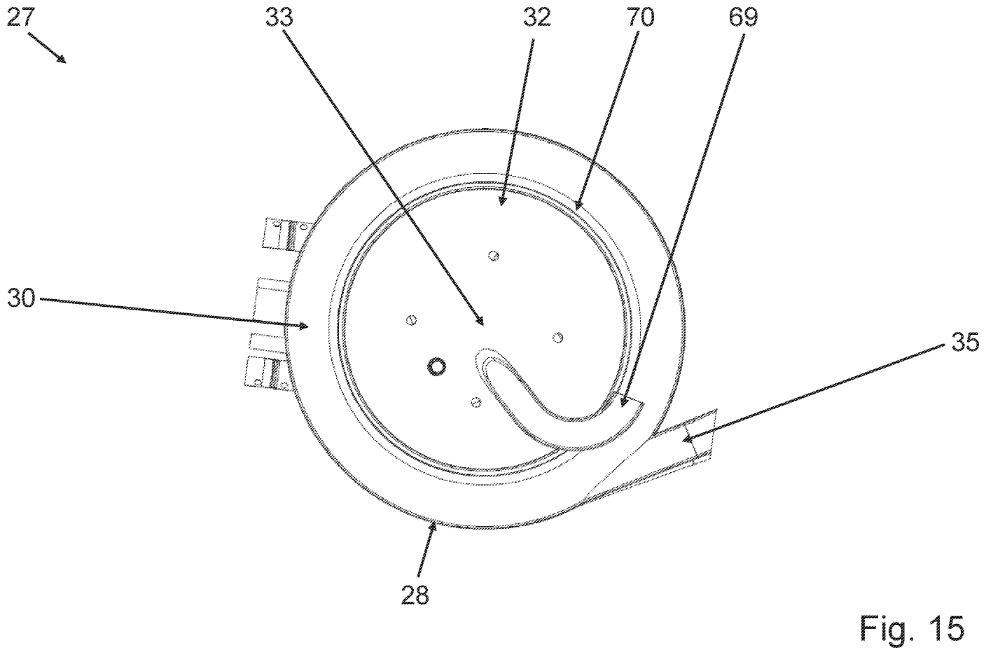

FIG. 12 represents a side view of the rotating device 28, which is attached to the building material distribution equipment 27. This rotating device 28 is formed by two or more torus-shaped rotor elements 29, 30 aligned parallel to each other, the rotor elements 29, 30 each being connected to an outgoing building material distribution line 34, 35. The rotor elements 29, 30 are connected to the circular disc-shaped stator elements 31, 32 (FIG. 13) by means of ring mounts 70 (FIG. 13) and are thus rotatably mounted. The ring mounts 70 (FIG. 13) between the stator elements 31, 32 (FIG. 13) and the rotor elements 29, 30 form a common axis of rotation 33 for the rotor elements 29, 30 of the rotating device 28, which are arranged axially next to each other. The rotor elements 29, 30 are each in fluidic connection with the associated stator element 31, 32 and each form a circular cross-section, which corresponds in diameter to that of the building material lines 34, 35, 36, 37. To ensure that the building material moves in the desired direction within the rotating device 28, a socket 69 is located at the end of the material lines 36, 37 (FIG. 15). This socket 69 directs the building material, which moves along the rotor elements 29, 30, until it leaves the rotating device 28 through the outgoing building material distribution lines 34, 35. By means of the rotating device 28, at least two building material lines 34, 35, 36, 37 can be twisted relative to each other without the building material supply lines 36, 37 of the building material lines and the building material distribution lines 34, 35 of the building material lines becoming twisted. In the illustration according to FIG. 12, a further through line 66 can also be seen which is guided through the stator elements 31, 32 of the rotating device 28. This through line 66 has a rotary coupling 67, which enables a rotation of the through line 66 about a line axis of this through line 66. When the building material lines 34, 35, 36, 37 are rotated relative to each other, the torus-shaped rotor elements 29, 30 on the circular disc-shaped stator elements 31, 32 rotate about the common axis of rotation 33 of the rotating device 28 so that the two building material lines 34, 35, 36, 37 are prevented from twisting around each other when they are rotated relative to each other at the ends of the building material supply lines 36, 37 or at the ends of the outgoing building material distribution lines 34, 35. Twisting of the building material distribution lines 34, 35, 36, 37 could happen without such a rotating device 28 if the movable carriage 7 of the apparatus 1 is guided in several self-contained laps during travel along the construction 3 to be manufactured with two building material distribution lines 34, connected. For example, the first spray nozzle 4 is supplied with building material for spraying via a first building material supply line 36 and a first building material distribution line 34. The second spray nozzle 26, on the other hand, is supplied with material for spraying via a second material supply line 37 and a second building material distribution line 35. The separate supply of the spray nozzles 4, 26 via the separate building material lines 34, 35, 36, 37 enables different material to be supplied quickly and easily to the respective spray nozzle 4, 26 via the building material distribution lines 34, 35 and the building material supply lines 36, 37. Water or other additives can be supplied to the spray nozzles 4, 26 separately to the building material via the further through line 66. For example, the building materials used are shotcrete.

In the illustration according to FIG. 13, a top view of the rotating device 28 according to FIG. 12 can be seen. Here it can be seen that the distribution pole 59 of the building material distribution equipment 27 is attached to the upper stator element 31. The upper rotor element 29 rotates on the stator element 31 about the axis of rotation 33 of the rotating device 28. The outgoing building material distribution line 34 goes off tangentially from the torus of the rotor element 29.

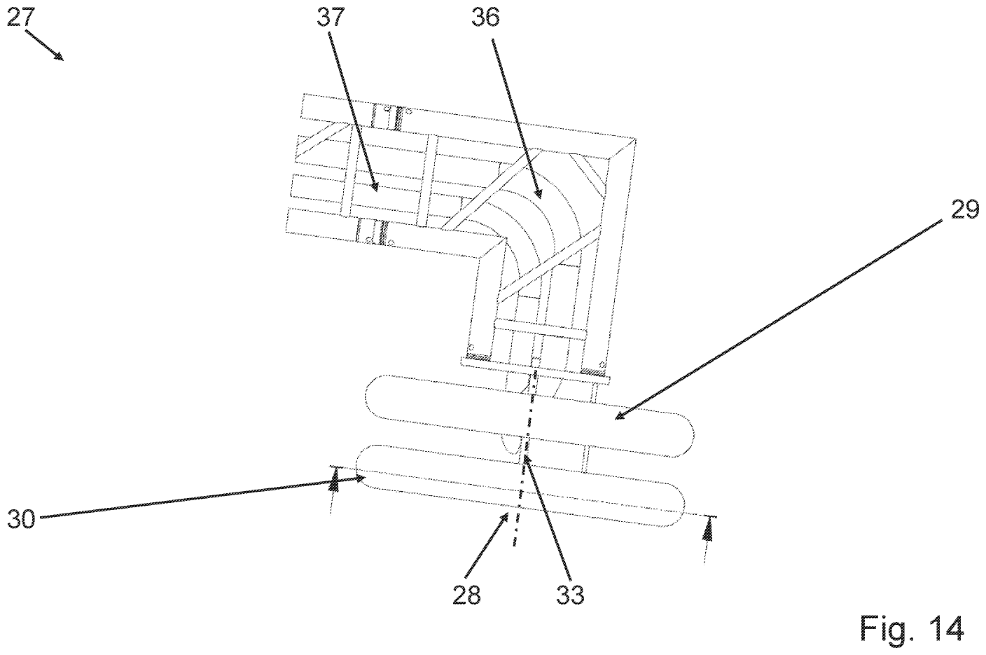

FIG. 14 shows another side view of the rotating device 28, with a sectional plane drawn here to indicate a section through the lower rotor member 30.

FIG. 15 shows a sectional view through the sectional plane indicated in FIG. 14. In this sectional view, it can be seen that the stator elements 31, 32 are each connected to an incoming building material supply line 37, which for example opens tangentially in the torus-shaped rotor element 30. In the same tangential direction, the building material distribution line 35 goes off tangentially from the rotor element 30. As a result, the building material is conveyed counterclockwise here by the building material supply lines 36, 37 in the rotor elements 29, 30 before being transported further via the outgoing building material distribution lines 35, 36. The building material supply lines 36, 37 and building material distribution lines 34, 35 can also be arranged in the opposite tangential direction so that the building material is conveyed clockwise in the rotor elements 29, 30.

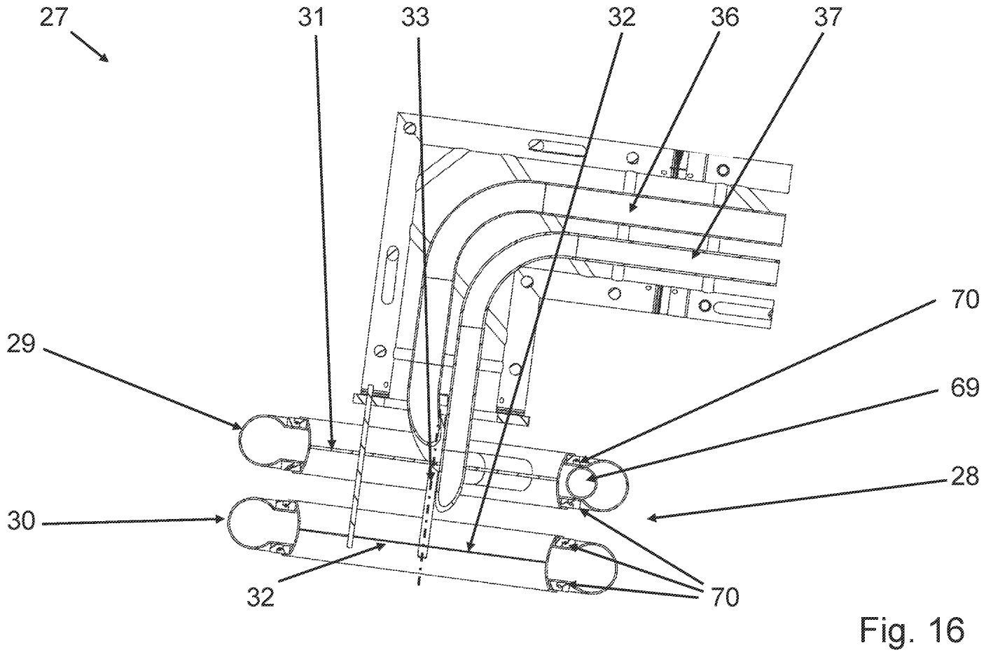

FIG. 16 shows another sectional view through the rotating device 28. In this sectional view, it can be seen that the two torus-shaped rotor elements 29, 30, which are aligned parallel to each other, are guided on the stator elements 31, 32 via the ring mounts 70. The ring mounts 70 (FIG. 13) between the stator elements 31, 32 (FIG. 13) and the rotor elements 29, 30 form the common axis of rotation 33 for the axially adjacent rotor elements 29, 30 of the rotating device 28 on the rotating device 28. When the building material lines 34, 35, 36, 37 are rotated relative to one another, the torus-shaped rotor elements 29, 30 rotate on the ring mounts 70 on the circular disc-shaped stator elements 31, 32 about the common axis of rotation 33 of the rotating device 28, so that the two building material lines 34, 35, 36, 37 are prevented from twisting around one another when they are rotated relative to one another at the ends of the building material supply lines 36, 37 or at the ends of the outgoing building material distribution lines 34, 35.

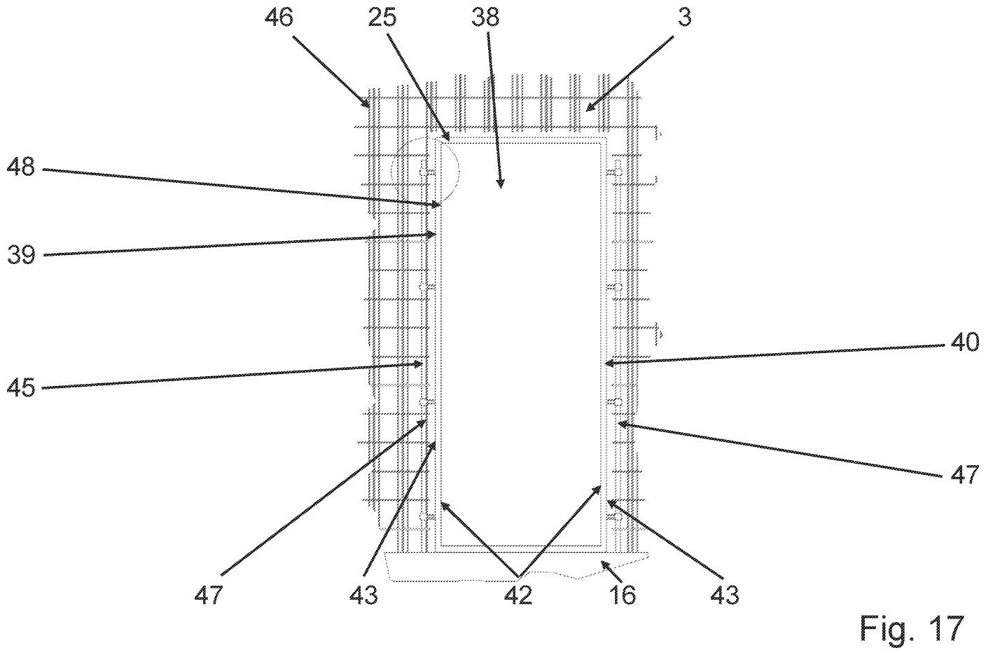

In FIG. 17, the recess formwork system 25, which is already shown in FIGS. 1, 3, and 7, for manufacturing a recess 38 for a door can be seen in more detail. FIGS. 1, 3, 5, 7, 8 and 10 also show a similar recess formwork system 25 for producing a recess for a window. One difference between the recess formwork systems 25 shown is the distance of the lower formwork board 39 from the subsoil and the length of the lateral formwork boards 39. In terms of function, the recess formwork systems 25 do not differ fundamentally, so that the recess formwork system 25 will be explained in more detail with reference to FIG. 17, without being limited to the production of recesses 38 for doors. The formwork boards 39 of the recess formwork system 25 form a door and/or window formwork 40, 41.

The formwork boards 39 have a back side 42 facing the recess 38 and a contact side 43. The contact side 43 forms the inside of the frame of the produced recess 38 during the manufacture of the solid, load-bearing construction from the building material to be sprayed on. Compared with conventional recess formwork system 25, the proposed system differs in that structural steel bars 45 are attached to the formwork boards 39 on the contact side 43 via spacers 44 of the recess formwork system 25. The structural steel bars 45 are attached to the ground slab 16 for positioning the door and/or window formwork 40, 41 so that the recess formwork system 25 is supported and fixed on the ground slab 16 via the structural steel bars 45.

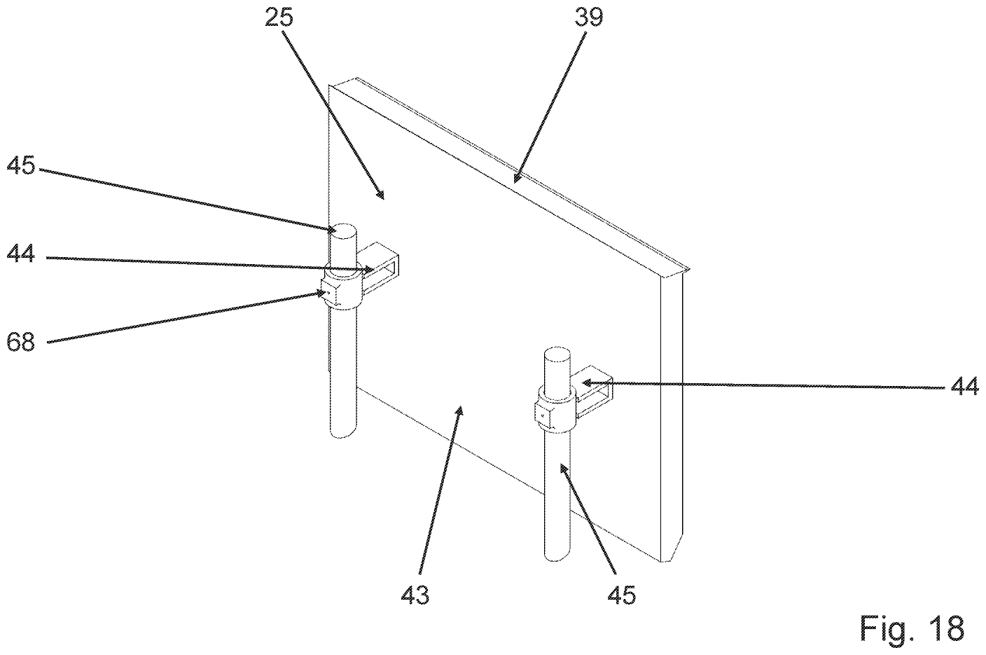

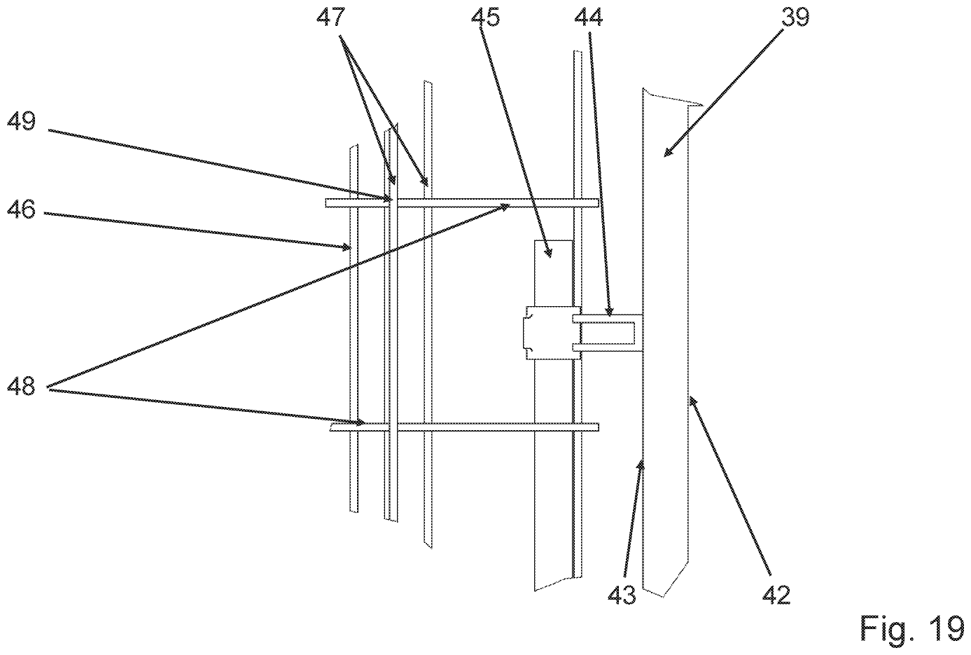

FIG. 18 represents a perspective view of the spacers 44 as shown in FIG. 17, while FIG. 19 represents an enlargement of the area marked in FIG. 17 onto the spacers 44. In both figures, it can be seen that the spacers 44 hold the structural steel bars 45 spaced from the side formwork boards 39 of the door and/or window formwork 40, 41. The recess formwork system 25 can be easily positioned via structural steel bars 45, which are held at a distance from the contact side 43 of the formwork boards via spacers 44. To prevent slippage, the spacers 44 are for example each secured with a Spax screw, which is screwed in at the screwing point 68 provided for this purpose. After completion, the structural steel bars 45 of the recess formwork system 25 remain in the solid, load-bearing construction and are surrounded by the hardening building material. Thus, the structural steel bars 45 further reinforce the area along the formed recess 38. After the building material has hardened, the spacers 44 are simply separated from the form boards 39 to reuse the remaining recess formwork system 25.

FIG. 20 shows a top view of a reinforcement mat 46. This reinforcement mat 46 comprises a plurality of intersecting bars 47, 48 which, connected to one another at crossing points 49, form a mat level 50. Of each of the bars 47, 48, a plurality of vertical bars 47 are aligned vertically along and parallel to each other and parallel to the mat level 50. Also, of the bars 47, 48, a plurality of horizontal bars 48 are each horizontally aligned longitudinally and parallel to each other and parallel to the mat level 50 and intersecting the vertical bars 47. A feature of the reinforcement mat 46 proposed herein is that at least two vertical bars 47 each extend grouped together and offset from each other orthogonally to the mat level 50 and on both sides of the horizontal bars 48. This can be seen for example well from the perspective in FIG. 20, which is directed towards the reinforcement mat 46 from the viewpoint of the course of the vertical bars 47 in the mat level 50. The double grouped vertical bars 47 running on either side of the horizontal bars 48 reinforce the reinforcement mat 46 so that it can stand upright independently, as seen for example in FIGS. 1, 3 and 7. The offset between the grouped vertical bars 47 ensures that building material sprayed onto the reinforcement mat 46 completely surrounds the bars 47, 48 without forming gaps between the building material and the bars 47, 48. For example, the reinforcement mats 46 are secured to the ground slab 16 by bonding the vertical bars 47 in pre-drilled holes on the ground slab 16.

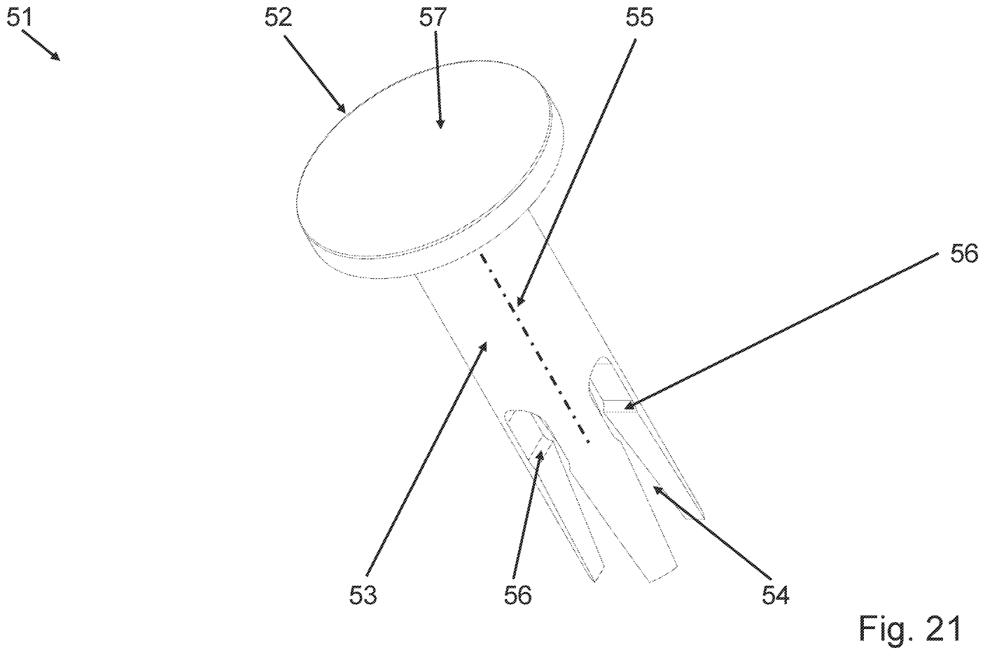

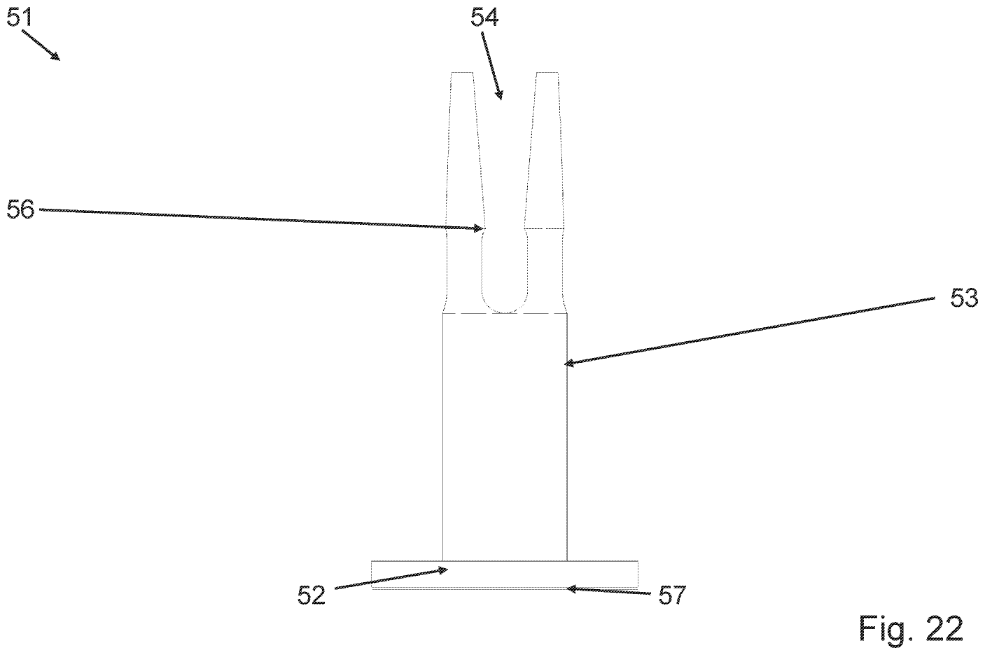

FIGS. 21 and 22, on the other hand, show a fastening element 51 for fastening at crossing points 49 of intersecting bars 47, 48. The fastening element 51 has a head 52 and a shank 53, the shank 53 having a cross-slot receptacle 54 recessed therein. The cross-slot receptacle 54 has undercuts 56 at each of the slots in the shaft direction 55 for clamping the fastening element 51 at the undercuts 56 when the intersecting rods 47, 48 are received in the shaft direction 55 in the cross-slot receptacle 54. The shank length between the undercuts 56 and the head 54 is selected to provide sufficient concrete cover.

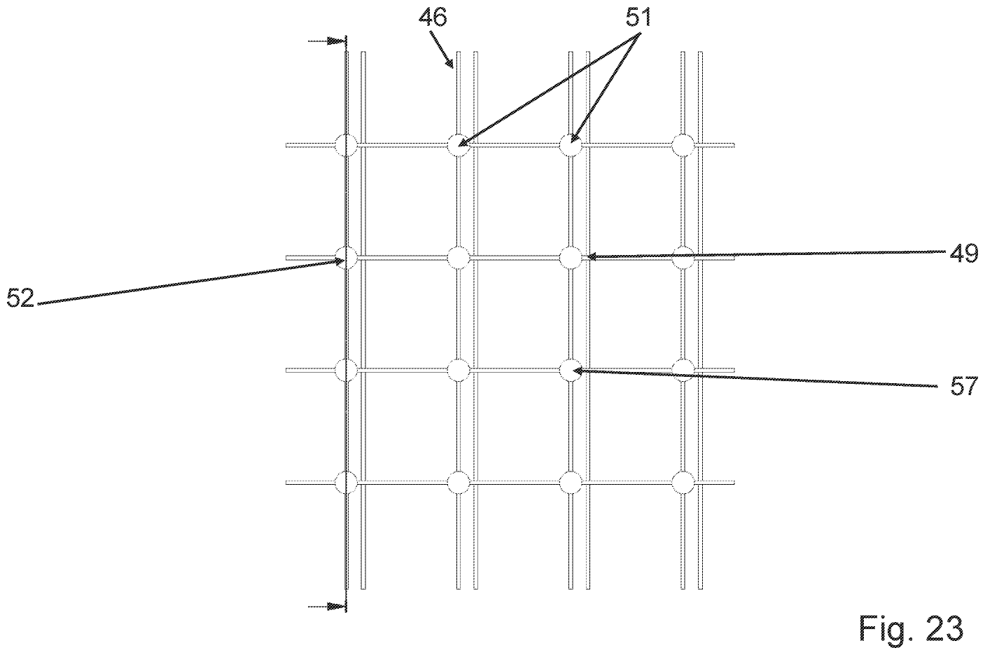

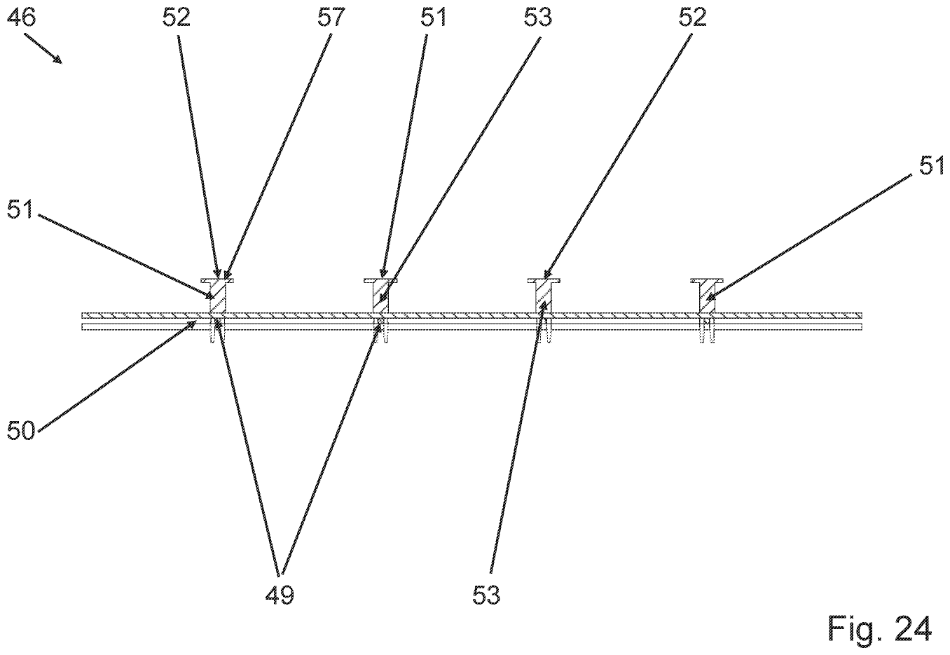

This can be seen in FIGS. 23 and 24, where several fasteners 51 are clamped to a reinforcement mat 46. FIG. 24 represents a sectional view through the sectional plane indicated in FIG. 23. The fastening elements 51 can be used for fastening protective foils 17 to the reinforcement mat 46. By clamping the fastening elements 51, they can be easily attached to the reinforcement mat 46 while maintaining the concrete cover. The protective foil 17 can then also be positioned independently of a formwork 2 and attached to the reinforcement 46 to spray a solid, load-bearing construction of hardening building material against the attached protective foil 17. The foil 17 can be fastened to the fastening element 51 for example easily if the head 52 has a self-adhesive mounting surface 57 on the back side opposite the shank 53. A protective foil 17 can be very easily adhered to the fastening elements 51 via this mounting surface 57.

The fastening elements 51 are then used together with the protective foil 17 in the case where a single wall is to be erected. In contrast to the previously described method, in which perimeter walls are erected by continuously driving around a ground slab or a floor slab, here stiffening walls or walls requiring fire protection can be erected by driving up and down a level several times.

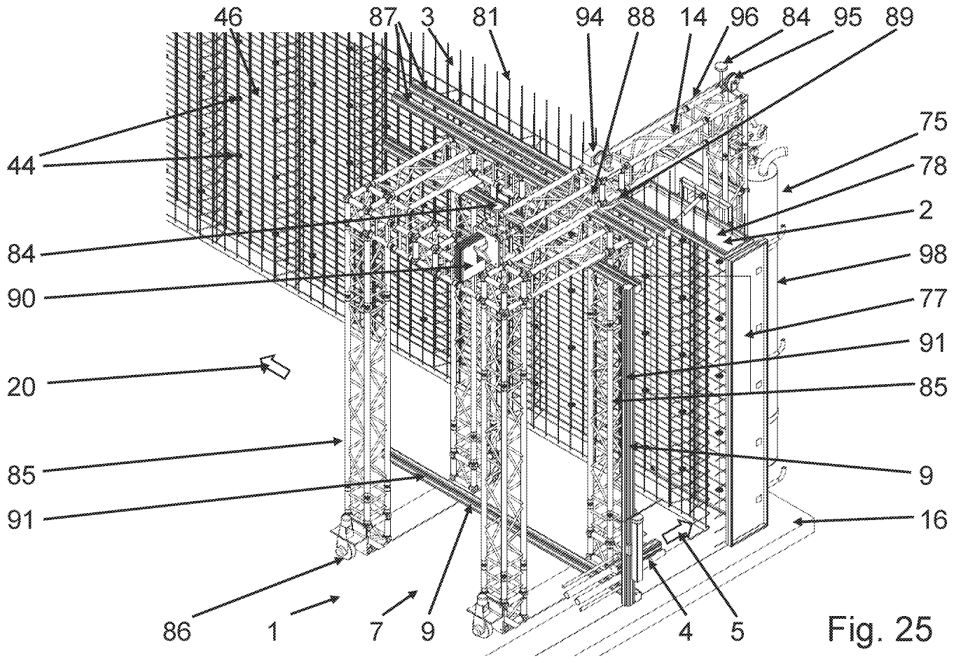

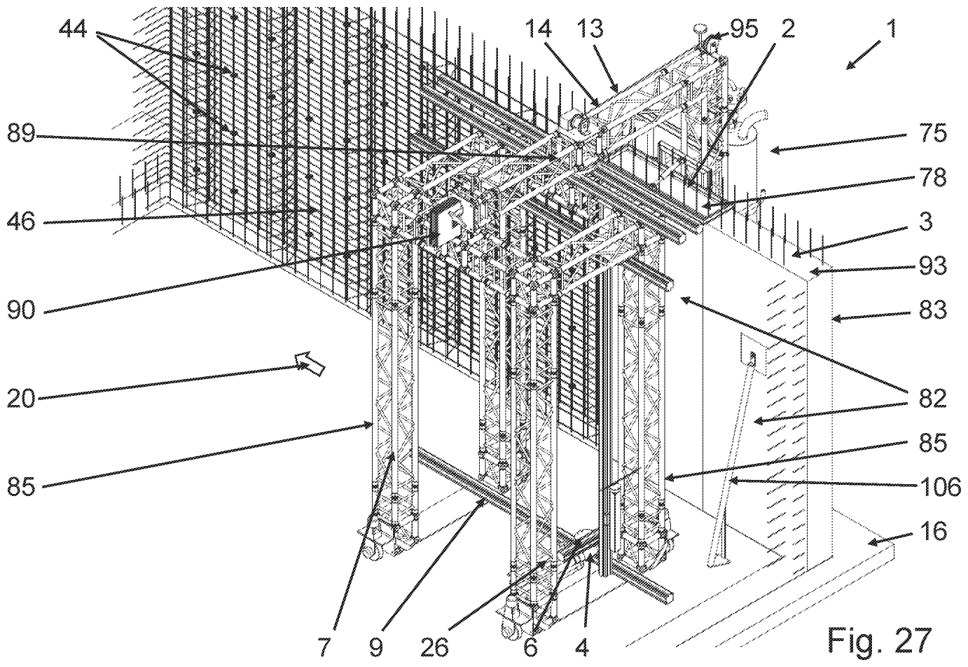

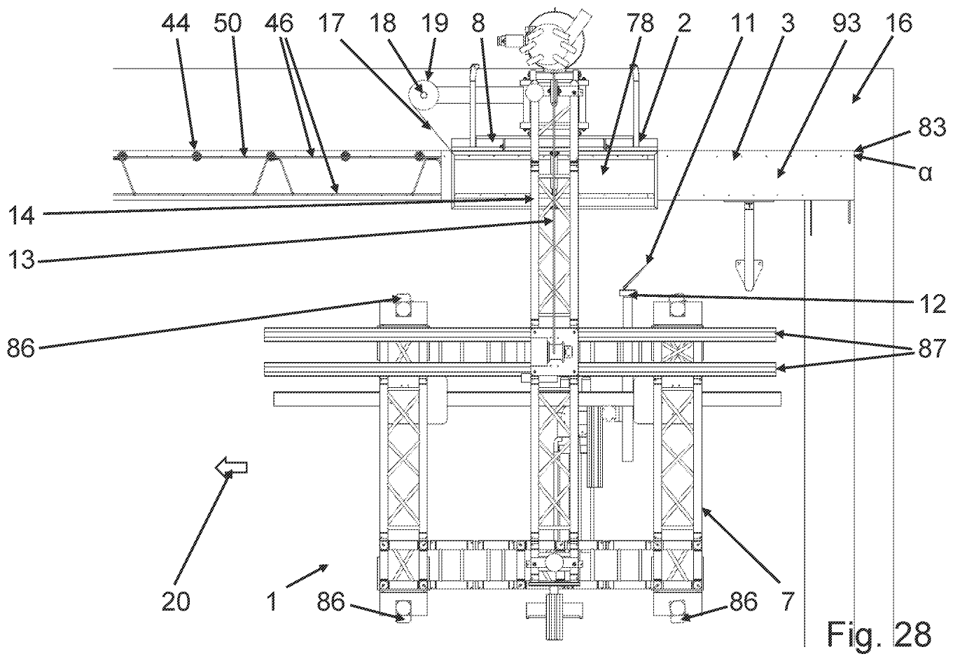

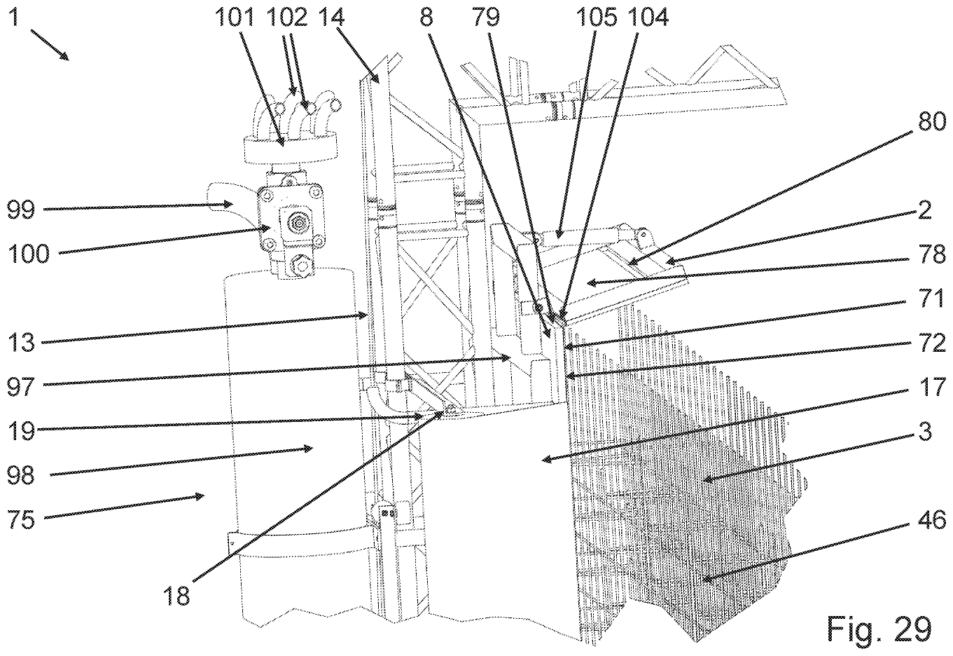

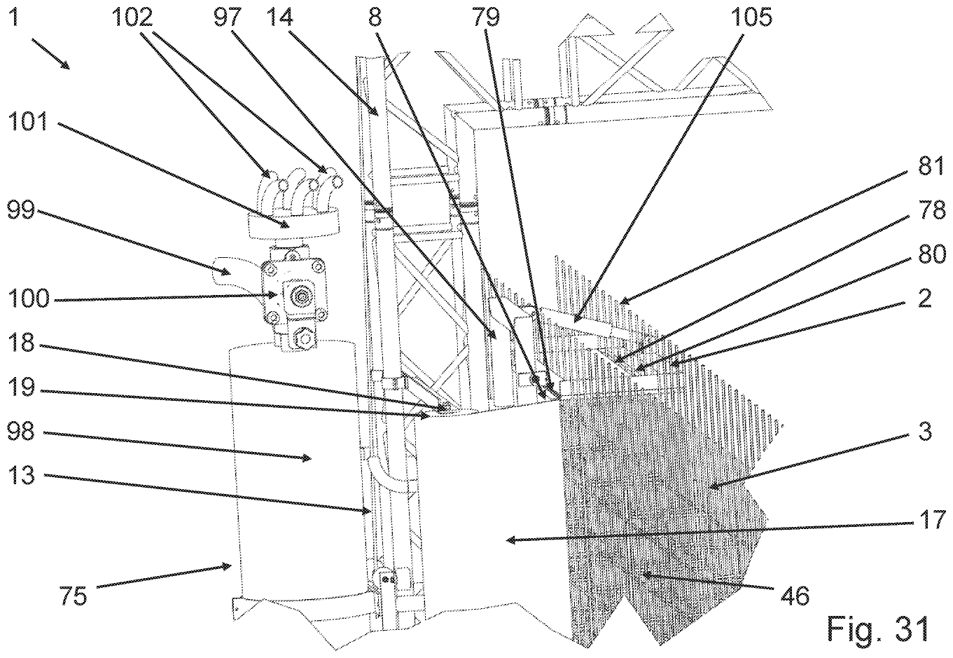

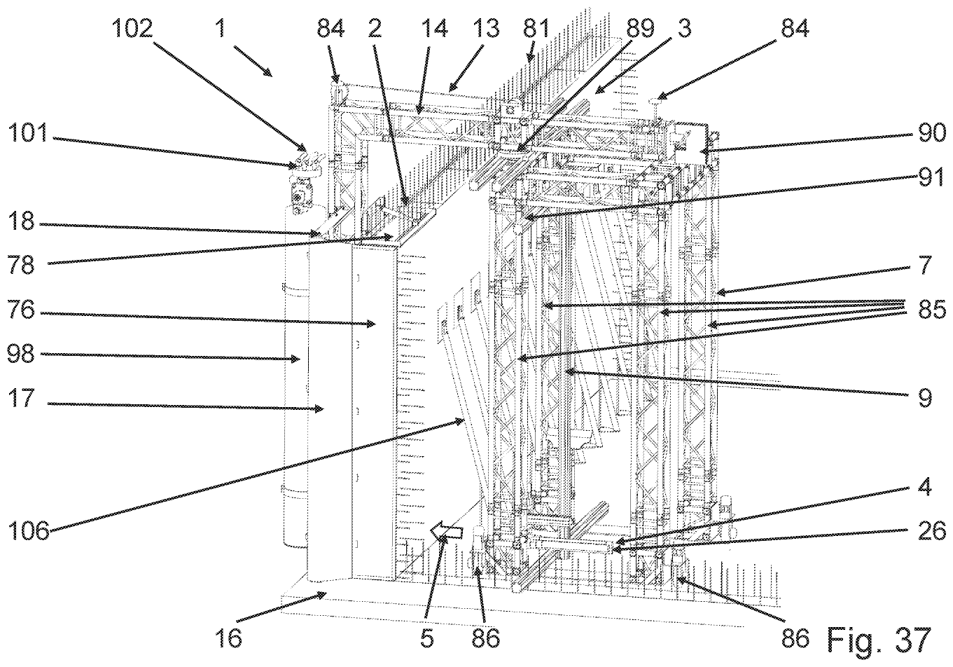

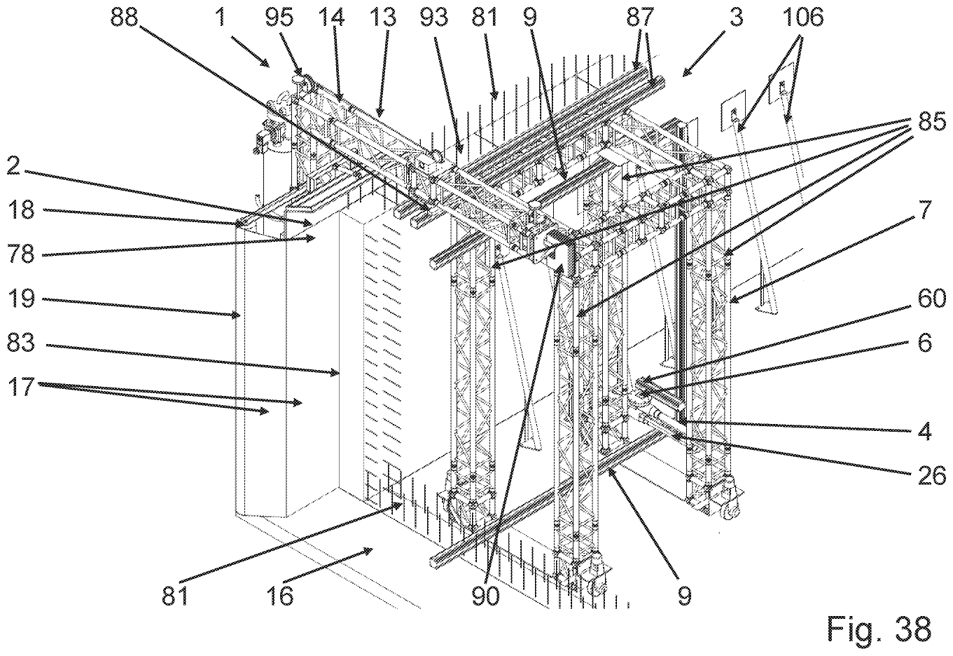

In FIG. 25, the reference sign 1 indicates an apparatus according to the disclosure in a further embodiment on a construction site. The apparatus 1 is used for applying a hardening building material against a formwork 2 for producing a wall of a building on a ground slab or floor slab 16. The apparatus 1 can also be used for the production of other solid, load-bearing constructions. For reinforcing the wall to be manufactured, conventional reinforcement mats 46 with a plurality of intersecting bars 47, 48, which are connected to each other at crossing points 49 to form a mat level 50 (FIG. 28), are set up on the floor slab 16. The apparatus 1 has a movable carriage 7, which for example can be moved autonomously along the erected reinforcement mats 46 during the application of the building material for manufacturing the load-bearing, solid construction from the hardening building material or from the building material that is stable due to compaction. For this purpose, the apparatus 1 for example has a Cartesian robot that controls the carriage 7 via programmable travel paths. The traversing of the construction 3 to be manufactured, such as the traversing of building edges 83, the positioning after individual traversing steps and the vertical alignment of the formwork during the application of the hardening building material is for example performed via a digital interface that has satellite navigation. For a for example high accuracy of the received satellite data, GPS/GNSS receivers 84 in combination with RTK correction (Real Time Kinematic) are for example provided on the apparatus 1. The necessary signals for the locomotion and orientation of the apparatus 1 are thus received via at least two GPS antennas 84 and converted into movements via interfaces. In the embodiment example, the carriage 7 is designed as a gantry crane, with four supports 85, at the lower ends of each of which are arranged separately drivable and separately steerable wheels 86. In order to compensate for unevenness of the subsoil 16, the wheels 86 can for example be controlled separately with regard to their height adjustment, and the rotational speeds can be controlled separately in order to travel along curved paths. The apparatus 1 shown here has two spray nozzles 4, 26 for spraying the building material in a spraying direction 5 and a manipulator 6 guiding the spray nozzles 4, 26 and prescribing the spraying direction 5. A first building material can be sprayed on via the two spray nozzles 4, 26 by means of the first spray nozzle 4 and a second building material different from the first building material can be sprayed on via the second spray nozzle 26 (FIG. 38). The manipulator 6 is mounted on a spray nozzle feed device 9 on the movable carriage 7. The spray nozzle feed device 9 is for example designed as a three-axis Cartesian robot. It is for example located between the supports 85 of the gantry crane. Only at the edges of the building 83 are the spray nozzles 4, 26 for applying building material moved by the spray nozzle feed device 9 outside the supports 85. The Cartesian robot of the spray nozzle feed device 9 has linear axes 91 which for example run parallel to the supports 85. These linear axes 91 are used to feed the spray nozzles 4, 26 by means of the spray nozzle feed device 9. In addition to a change in the height of the spray nozzles 4, 26, the spray nozzles 4, 26 can also for example be positioned in the direction of the construction 3 to be manufactured by means of the spray nozzle feed device 9 via a linear drive 60 (FIG. 38). A circulating movement of the spray nozzles 4, 26 is also possible. The linear drive 60 ensures the required distance of the spray nozzles 4, 26 from the wall surface as the wall thickness increases during the spraying process. The manipulator 6 can be used, for example, to change the inclination of the spray nozzles 4, 26, in order, for example, to enable uniform distribution during application of the building material and to avoid spray shadows. This can also be achieved by uniformly swiveling the spray nozzles 4, 26 up and down when applying the building material via the automatic manipulator 6. For this purpose, the manipulator 6 has a rotary head that moves the spray nozzles 4, 26 back and forth in a vertical and/or horizontal direction. On the upper side of the gantry crane there are for example two bridge girders 87 on which a trolley 88 is mounted. This trolley 88 for example has a motor slewing ring 89 on which a bracket jib 14 is mounted. The bracket jib 14 holds a formwork panel 8 on the movable carriage 7. A counterweight 90 for the formwork panel 8 is provided at the opposite end of the bracket jib 14. The bracket jib 14 can be rotated and moved on the bridge girders 4 depending on the control of the trolley 88 and the motor slewing ring 89. The bracket jib 14 extends in a portal-like manner over the construction 3 to be manufactured, so that the formwork panel 8 and the spray nozzles 4, 26 are positioned on opposite sides of the construction 3 . . . . A formwork 2 is formed by the formwork panel 8, which is movable together with the carriage 7 and is positioned relative to the spray nozzles 4, 26 in the spraying direction 5 and is oriented substantially transversely to the spraying direction 5. This allows the formwork 2 to be easily guided in the spraying direction 5 in front of the spray nozzles 4, 26 held by the manipulator 6. Thus, via an automatically movable carriage 7 on which an automatic manipulator 6 is mounted, automatically hardening construction material can be applied against the formwork 2 via the spray nozzles 4, 26 guided by the manipulator 6 to produce a solid, load-bearing construction 3. To produce the solid, load-bearing construction 3, for example a wall of a building, from a building material that hardens or is stable due to compaction, the building material is simply applied against the formwork 2, with the manipulator 6 guiding the spray nozzles 4, 26 to spray on the building material and prescribing a spraying direction 5 of the spray nozzles 4, 26. If the carriage 7 is moved along the construction 3 to be manufactured on a subsoil 16, the formwork 2 formed by the formwork panel 8 also moves together with the carriage 7 in the direction of travel 20. The formwork panel 8 is positioned relative to the spray nozzle 4 in the spraying direction 5 for applying the building material and is oriented substantially transversely to the spraying direction 5 when applying the building material. For example, the carriage 7 of the apparatus 1 is moved stepwise along the construction 3 to be manufactured, wherein between the travel steps of the carriage 7 the construction 3 to be manufactured is completed section by section by adjacent sections 82 (FIG. 27) by means of application of the building material, which is hardening or stable by compaction, against the formwork 2 of the apparatus 1. Via the step-by-step movement of the carriage 7 on the subsoil 16, the construction 3 to be manufactured, in this case a building wall, can very easily be applied in sections from hardening building material or building material stable by compaction by spraying with the spray nozzles 4, 26 against the same formwork 2. The formwork 2 thus serves as a sliding formwork which can be moved step by step by moving the carriage 7. The adjacent sections 82 (FIG. 27) of the construction 3 to be manufactured can thus be formed one after the other with the sliding formwork, which moves stepwise in the direction of travel 20 along the construction 3 to be manufactured. After positioning the formwork 2 by moving the carriage 7, the hardening building material can be applied against the formwork 2 section by section 82. The reinforcement mat 46 is for example fastened to the subsoil 16 before the hardening building material is applied to the formwork 2 and is located between the spray nozzles 4, 26 and the formwork 2 during the manufacture of the construction 3 by the application of the hardening building material. The connection reinforcement 81 for example projects from the subsoil 16 for fastening the reinforcement mat 46. Reinforcing mats 46 are attached to this connection reinforcement 81 with wire rods. Commercially available spacers 44 are used to ensure concrete cover in the direction of the formwork panel 8. In the embodiment shown here, the formwork 2 also comprises edge formwork 76 (FIG. 37), 77, which are designed to be arranged laterally flush with the formwork panel 8 at an angle α to the formwork panel 8. The edge formwork 76 (FIG. 37), 77 are used to produce edges 83 of the construction 3 to be manufactured with the apparatus 1. For this purpose, the edge formwork 77 of the formwork 2 is simply arranged laterally flush with the formwork panel 8 at a defined angle, here 90 degrees, to the formwork panel 8. Thus, when the building material is sprayed onto the formwork panel 8, a lateral closure of the construction 3 to be manufactured is formed on the edge formwork 77 at the angle α formed between the formwork panel 8 and the edge formwork 77 (FIG. 28). The lateral finish can be used to create building edges 83, as shown in FIG. 25, by arranging the edge formwork 77 flush with the side of the formwork panel 8 before the building material is sprayed on. The formwork 2 also has a final formwork 78, which is designed to be arranged flush on an upper side 79 (FIG. 29)of the formwork panel 8 at an angle β (FIG. 31) to the formwork panel 8. The final formwork 78 on the upper side 79 of the formwork panel 8 makes it possible to manufacture an upper end of the construction 3 to be manufactured. In this way, for example, support surfaces 93 (FIG. 27) for floor slabs can be produced in the construction 3 to be manufactured. For this purpose, the final formwork 78 forms an upper closure under which the construction 3 to be manufactured is created by spraying building material onto the formwork panel 8. The final formwork 78 has at least one slot 80 (FIG. 29) for receiving connection reinforcement 81. As can be seen in FIG. 25, this allows the connecting reinforcement 81 of the construction 3 to be manufactured to simply protrude from the end formwork 78 after the formwork 2 has been positioned. This makes it for example easy to form non-positive connections between the manufactured wall and the floor slabs 16 on the construction 3 to be manufactured. The connecting reinforcement 81 can project through the slot 80, but building material sprayed onto the formwork panel 8 remains as far as possible under the final formwork 78 and forms here a smooth upper surface of the construction 3 to be manufactured, from which the connecting reinforcement 81 projects. The final formwork 78 is for example provided with a rubberized surface. In the case shown here, a formwork feed device 13 also serves for vertical positioning of the formwork panel 8, so that the height of the formwork panel 8 can be changed by the formwork feed device 13 via a vertical, translatory movement of the formwork 2 on the bracket jib 14. In the embodiment example, the formwork feed device 13 is equipped with a winch 94 and an idler pulley 95, by means of which the formwork 2 can be raised and lowered from the subsoil 16 on a cable pull 96. The formwork panel 8 of the formwork 2 is for example attached to a metal frame 97, which slides along the bracket jib 14 for this purpose. For moving the carriage 7 the formwork 2 can be raised from the subsoil 16 via the formwork feed device 13 of the apparatus 1 and can be lowered again on the subsoil 16 for applying the hardening building material. To move the carriage 7, the formwork 2 must be raised to such an extent that the formwork panel 8 is located above the ends of the connecting reinforcement 81. The formwork feed device 13 makes it easy to raise the formwork 2 for moving the carriage 7 to produce the next construction section 82. As soon as the position for the next construction section 82 has been reached, the formwork 2 can be set down again on the subsoil 16 by means of the formwork feed device 13, after the excess length of the protective foil 17 has for example been blown into the gap between the formwork 2 and the subsoil 16 by means of compressed air, which foil is turned up around the lower edge of the formwork, so that the formwork 2 together with the protective foil 17 seals to the subsoil 16. After this, the application of the hardening building material or the building material that has become stable through compaction against the formwork 2 can be continued in the next construction section 82.

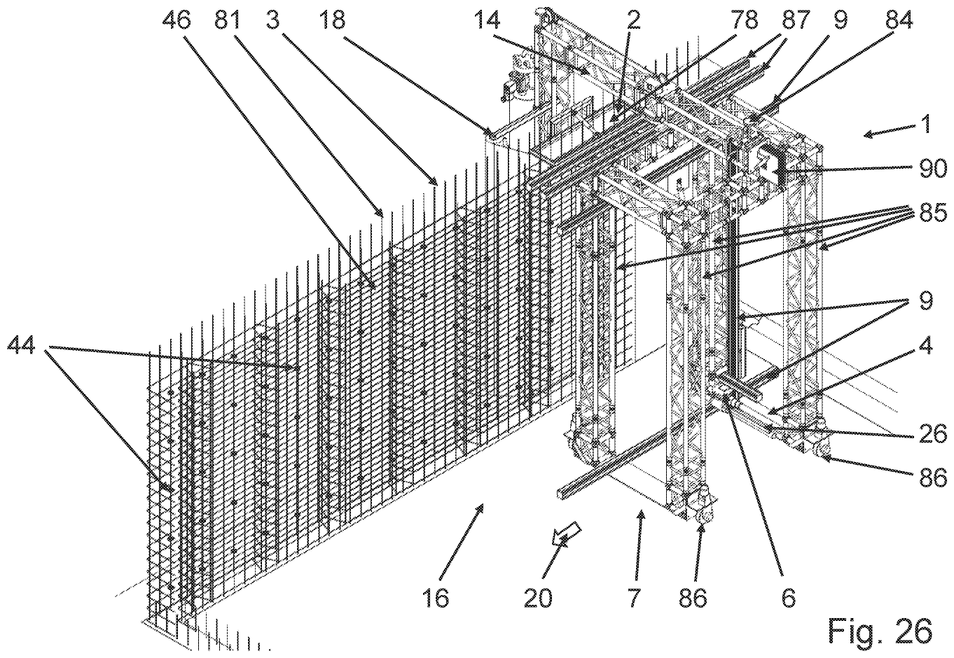

This is shown in FIG. 26, in which the apparatus 1 shown in FIG. 25 has been displaced to produce the next section 82 by moving the carriage 7 laterally in the direction of travel 20 along the construction 3 to be manufactured.

FIG. 27 shows the apparatus 1 in the position already assumed in FIG. 26. Here, the adjacent section 82 of the construction 3 to be manufactured has also been manufactured by spraying hardening building material against the formwork panel 8. Thus, the carriage 7 of the apparatus 1 can be moved stepwise along the construction 3 to be manufactured. Between the travel steps of the carriage 7, the construction 3 to be manufactured can simply be manufactured section by section by adjacent sections 82 by means of applying the hardening building material against the formwork 2 of the apparatus 1.

In FIG. 28, the apparatus 1 is shown in the position shown in FIG. 27 from a bird's-eye view in a plan view. In this representation, an unwinding device 18 can be seen, which is designed to unwind a protective foil 17 from a roll 19 and guide it over the formwork panel 8. In this way, the formwork panel 8 is protected from the sprayed-on building material by the protective foil 17 sliding over the formwork panel 8. The unwinding device 18 unwinds the protective foil 17 from the roll 19 against the direction of travel 20 of the carriage 7. This can be done at a circumferential speed that is equal in amount to the travel speed of the carriage 7. In this way, a continuous protective foil 17 can be used for adjacent construction sections 82 of the construction 3 to be manufactured. On the section 82 of the construction 3 manufactured by the respective spraying process, the unwound protective foil 17 remains on the construction 3 to be manufactured when the carriage 7 is moved for post-treatment. FIG. 28 also shows that the apparatus 1 has a darby 11 which is used for drawing off the sprayed-on construction material. For example, the darby 11 is positionable relative to the carriage 7 by means of a darby feed device 12 attached to the manipulator 6. The automatic darby feed device 12 enables the angle of the darby 11 on the manipulator 6 to be changed. The height of the darby 11 can be changed via the manipulator 6 and a translatory, substantially horizontal movement of the vertically oriented darby 11 can be performed. The darby 11 at the darby feed device 12 is slightly angled and has a vertical extension over which the surfaces of the construction 3 to be manufactured can be smoothly drawn off when the darby 11 is guided along the construction 3 to be manufactured via the manipulator 6. The darby 11 is for example formed by an angled rubbing board, which is guided along the construction 3 to be manufactured via the darby feed device 12.

FIG. 29 shows a detailed view of the roll 19, which is unrolled over the formwork 2 by the unwinding device 18 in the direction of travel 20 in front of the formwork panel 8. This protects the formwork panel 8 with protective foil 17 from the building material which is sprayed against the formwork panel 8 with the spray nozzles 4, 26 (FIG. 27). The formwork panel 8 has a vacuum clamping surface 71, described in more detail later, which is designed to clamp the protective foil 17 plane on the formwork panel 8. FIG. 29 shows a vacuum tank 98 of the vacuum source 75, which provides the vacuum for clamping the protective foil 17 on the formwork panel 8. The vacuum tank 98 is connected to a vacuum pump of the vacuum source 75 via a conduct 99. In addition, the vacuum tank 98 is connected to the formwork panel 8 via a valve 100, for example a solenoid valve, and a distributor 101. For this purpose, several vacuum hoses 102 lead from the distributor 101 into the formwork panel 8. After a vacuum has formed in the vacuum tank 98 starting from the vacuum pump, the protective foil 17 is sucked onto the vacuum clamping surface 71 by triggering the valve 100. Further operation of the vacuum pump thus creates a force-fit connection between the protective foil 17 and the formwork panel 8. This force-fit connection is important for the function of the protective foil 17, because it achieves adhesion of the applied building material to the protective foil 17. The material application is not affected by tangential forces that would lead to deformation of the protective foil 17. In addition, the production of floor-high sections is possible due to the holding force of the vacuum on the protective foil 17, since otherwise there is a risk of the fresh wall elements collapsing even before they are supported. The apparatus 1 can be used to produce walls with reinforcement in any number of layers and layer thicknesses with different materials. Thus, first an outer shell with concrete in the required exposure class and minimum thickness, in the next layer insulating concrete, then the supporting shell and finally also an interior plaster can be applied to the walls to be produced. The construction of, for example, a concrete wall with the apparatus 1 proceeds in sections. First, concrete mortar is applied through a spray nozzle 4 (FIG. 27), then shotcrete is applied through another spray nozzle 26 (FIG. 27) in order to minimize rebound. These construction materials impinge on the formwork panel 8, which is covered with protective foil 17. In the width of the produced section 82 (FIG. 27), the protective foil 17 remains on the back of the shotcrete wall and is used for post-treatment of the concrete. FIG. 29 also shows in detail the final formwork 78 on the upper side 79 of the formwork panel 8. In this view, it can be seen that the final formwork 78 can be pivoted relative to the formwork panel 8 by means of a linear motor 105. This allows the obtuse angle β between the end formwork 78 and the formwork panel 8 to be easily changed. For this purpose, the final formwork 78 is for example attached to the formwork panel 8 by a hinge 103. As can be seen in FIG. 29, the formwork 2 can be moved relative to the construction 3 to be manufactured by moving the carriage 7 along the construction, since the formwork 2 has been raised by the formwork feed device 13 to such an extent that the connecting reinforcement 81 does not project into the slots 80 of the final formwork 78.

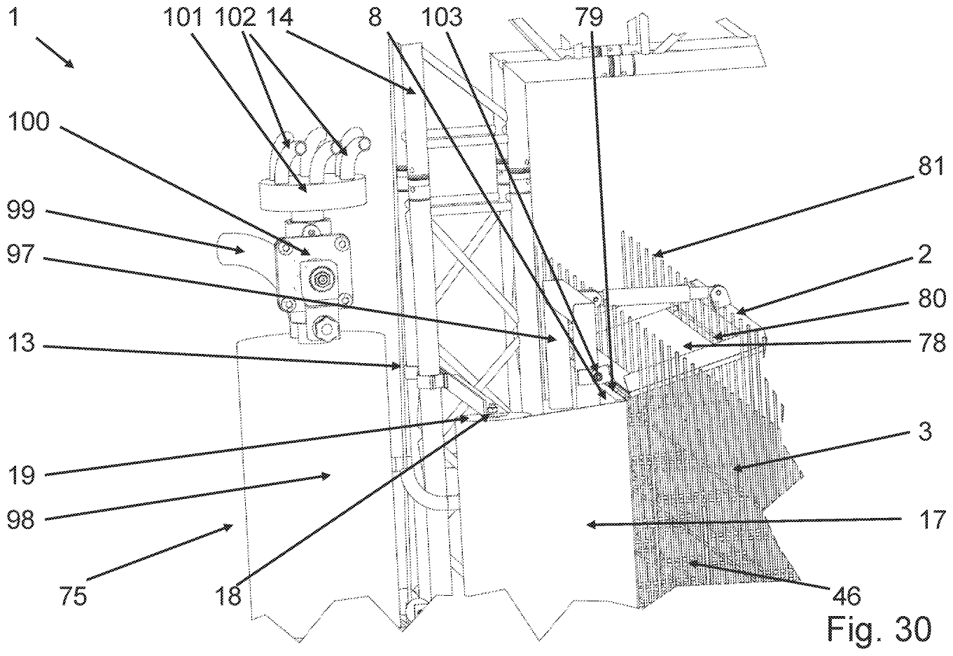

The illustration according to FIG. 30 shows the formwork panel 8 in the position so that the connecting reinforcement 81 protrudes through the slots 80 of the final formwork 78 The upper edges 79 of the formwork panel 8 and the protective foil 17 are flush with each other in this position. The roll 19 is firmly mounted on the bracket jib 14 with the unwinding device 18. For this reason, the formwork panel can be raised and lowered for positioning independently of the protective foil 17 by means of the formwork feed device 13. The protective foil 17 is clamped between the formwork panel 8 and the final formwork 78 by extending the linear motor. For this purpose, the final formwork 78 has a for example glued-in clamping rubber 104 (FIG. 29).

In FIG. 31, it can be seen that by actuating the linear motor 105, the angle β between the final formwork 78 and the formwork panel 8 has been changed compared to the position according to FIG. 30. Through this, a right-angled upper termination of the construction 3 to be manufactured can be realized. In addition, the shown feed of the linear motor 105 clamps and fixes the protective foil 17 on the upper side 79 of the formwork panel 8 by means of the clamping rubber 104 (FIG. 29) of the final formwork 78. The protective foil 17 is for example longer towards the bottom than the formwork panel 8, the protrusion formed by this being blown through the gap between the formwork panel 8 and the subsoil 16 by means of compressed air. To protect the formwork panel 8 from dust and building material and to seal it, the protective foil 17 is wrapped around the lower edge of the formwork panel 8. The formwork panel 8 is then lowered onto the subsoil 16 by means of the formwork feed device 13. After the flush arrangement of the protective foil 17 on the formwork panel 8, a vacuum is generated via the vacuum clamping surface 71 and the protective foil 17 is clamped on the formwork panel 8.

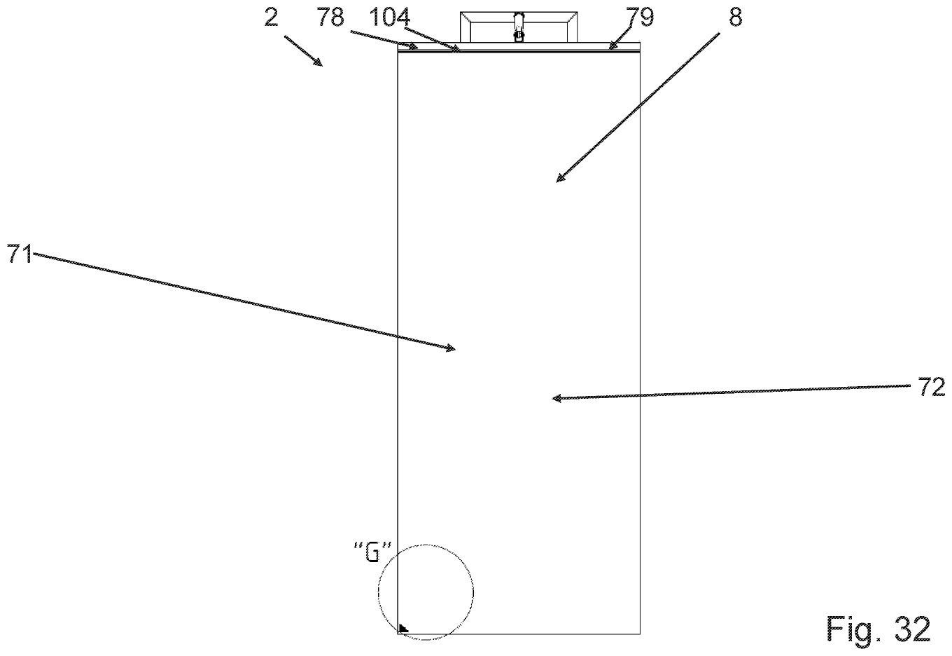

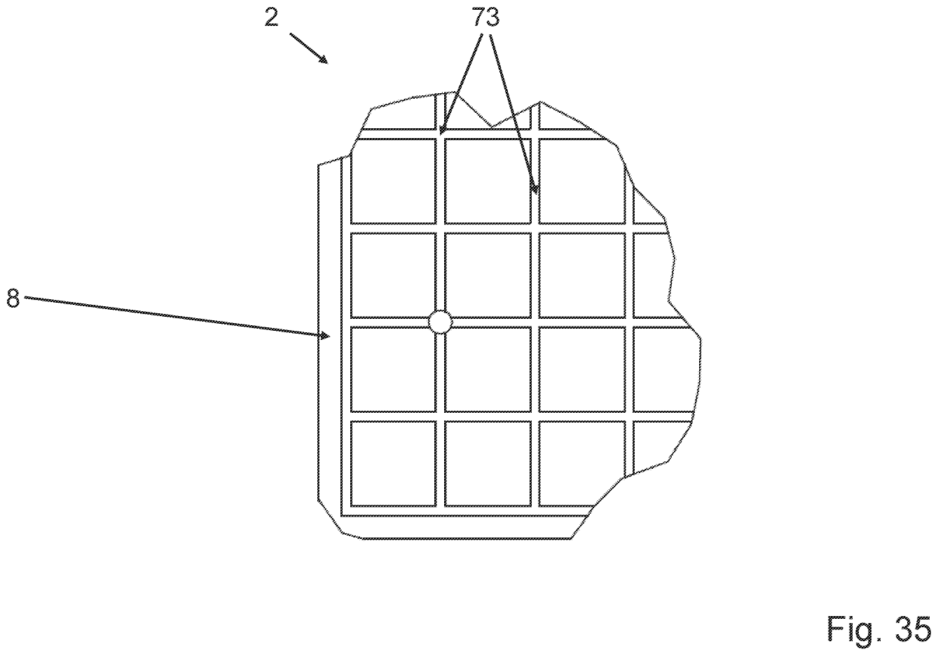

FIG. 32 shows a single view of the formwork panel 8. Here, the vacuum clamping surface 71 can be seen on the formwork panel 8. This vacuum clamping surface 71 is used to clamp the protective foil 17 plane on the formwork panel 8. In this way, the protective foil 17 can be stretched for example easily and securely in a smooth state on the formwork panel 8. The wrinkle-free fitting protective foil 17 is thus securely supported on the formwork panel 8 and excellently protected from damage, such as punctures. As a result, the sprayed-on building material does not come into direct contact with the formwork panel 8. Nevertheless, the sprayed-on building material is sufficiently compacted on the protective foil 17 and the rebound is minimized. The vacuum clamping surface 71 is for example formed by a perforated plate 72 with connecting channels 73 behind it (FIG. 35). For further explanation of the connecting channels 73 (FIG. 35), an area G is highlighted in FIG. 32, which will be explained below.

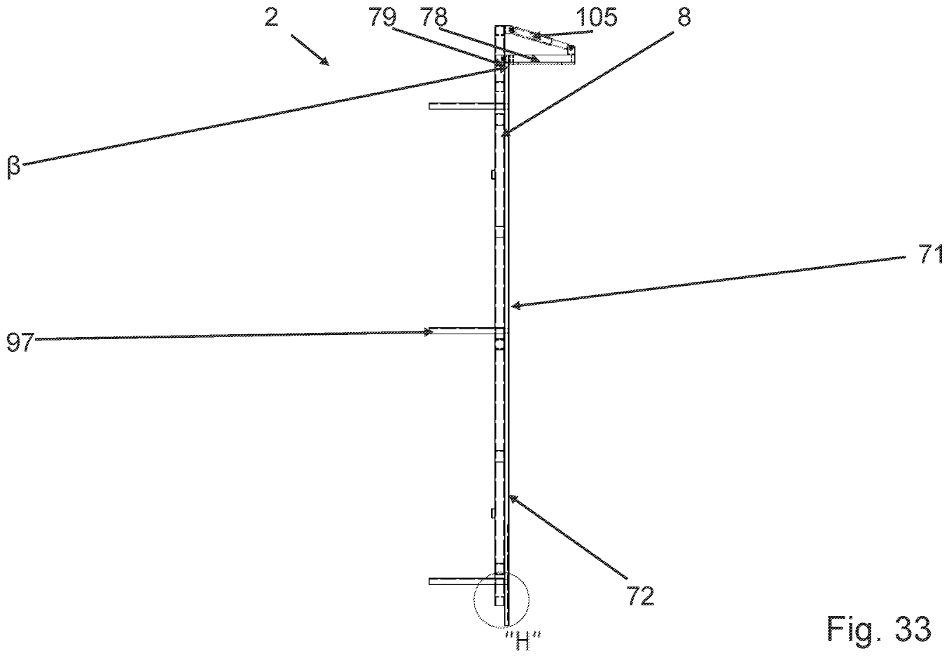

In FIG. 33, the formwork panel 8 according to FIG. 32 is shown in a side view. Here it can be seen that the formwork panel 8 is attached to a metal frame 97, which can slide along the bracket jib 14 in order to feed the formwork panel 8 vertically. In FIG. 33, an area H is also drawn.

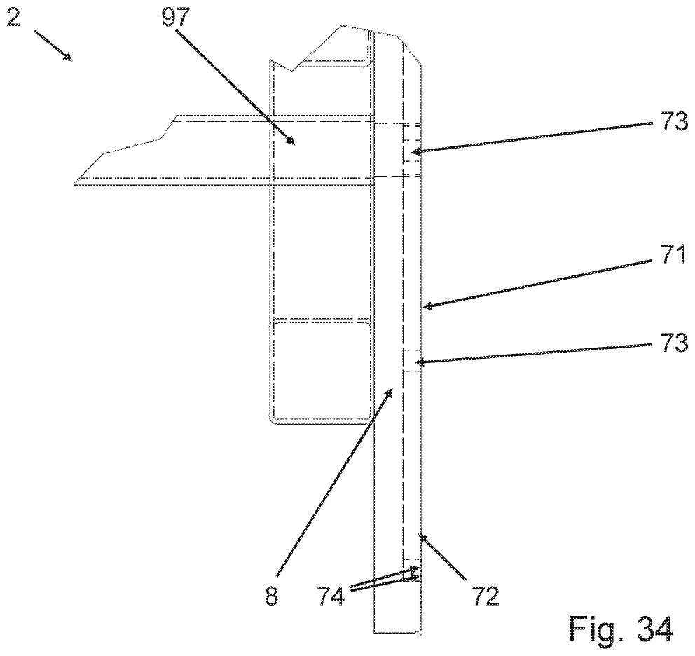

This area H is shown enlarged in FIG. 34. Here it can be seen that the perforated plate 72, which for example has a thickness of 1 mm, rests on the remaining formwork panel 8. For example, the perforated plate 72 is simply glued airtight at the edges. The perforated plate 72 with its large number of very small holes ensures that the surface of the aspirated protective foil 17 (FIG. 29) remains smooth and no construction is visible.

The area G according to FIG. 32 is shown in FIG. 35 without the perforated plate 72 (FIG. 32) so that the connecting channels 73 behind it are visible. These connecting channels 73 form grooves that are covered on the open side by the perforated plate 72 (FIG. 32). Thus, the connecting channels 73 connect several holes in the perforated plate 72 (FIG. 32) with a vacuum source. Thus, when the protective foil 17 is stretched, the holes in the formwork panel 8 suck it in via the vacuum generated by the vacuum source. For this purpose, the connecting channels 73 arranged behind the perforated plate 72 (FIG. 32) transfer the generated vacuum to several holes in the perforated plate 72 (FIG. 32) opening into the connecting channels 73.

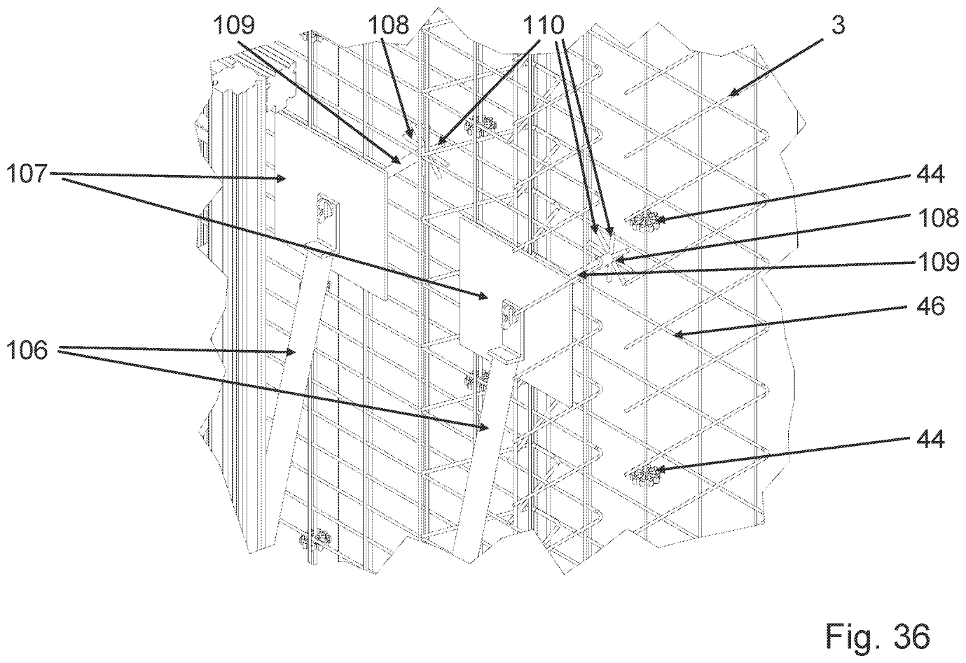

FIG. 36 shows a detailed view of the supports 106 with which the construction 3 to be manufactured can be supported until complete hardening. The supports 106 have sheet metal plates 107 which serve to better absorb compressive forces on the still fresh, highly viscous building material. The supports 106 are attached as soon as the desired layer thickness of the building material has been applied. Only after the supports 106 have been attached can the protective foil 17 resting on the supported section 82 be removed from the formwork panel 8 by releasing the vacuum. The supports 106 are bolted to special steel baskets 108. The steel baskets 108 have a threaded central tube 109 for receiving a threaded formwork rod. From the tube 109 extend in a star-shaped manner reinforcing bars 110, which are attached to the inner and outer sides of the reinforcement mats 46 by means of rod wire and, together with the applied building material, form a fixed anchorage point for the supports 106.

In FIG. 37, the apparatus 1 as shown in FIG. 25 has been moved with the carriage 7 step by step along the construction 3 to be manufactured up to the next building edge 83. Between the individual travel steps of the carriage 7, the construction 3 to be manufactured, in this case the building wall, was produced in sections by adjoining sections 82 by applying the hardening building material against the formwork 2 of the apparatus 1. Having reached the building edge 83, an edge 83 of the construction 3 to be manufactured is produced by the edge formwork by arranging an edge formwork 76 of the formwork 2 laterally flush with the formwork panel 8 at an angle α, here a right angle, to the formwork panel 8.

Once the complete building wall has been completed, the apparatus 1 is rotated according to the following steps in order to manufacture the next building wall, which adjoins at 90°.

First, the formwork panel 8 is moved to the edge of the building 83, as shown in FIG. 38. Then the formwork panel 8 is separated from the protective foil 17 and the metal frame 98 with the formwork panel 8 is lifted until the final formwork 78 is above the connecting reinforcement 81. The trolley 88 is moved parallel to the finished building wall until the pivot point is outside the finished building wall.

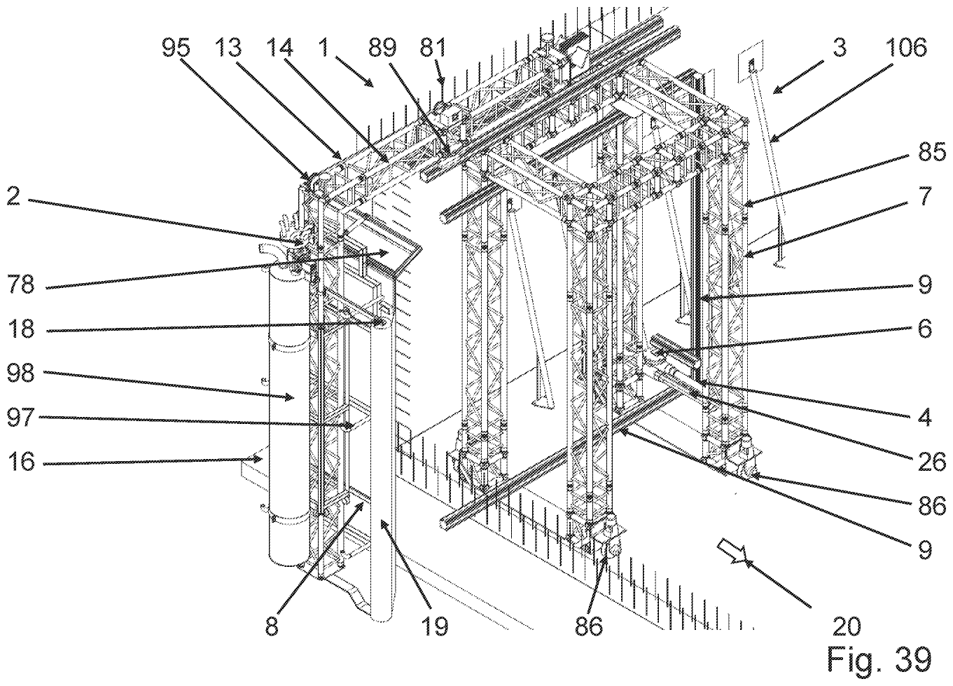

Subsequently, the bracket jib 14 is rotated 90° on the motor slewing ring 89, as can be seen in FIG. 39. The carriage 7 then moves in the opposite direction to the fabricated building wall to allow room for the subsequent movements. The carriage 7 then turns the spray nozzles 4, 26 in the direction of the wall to be produced from the building edge 83 and the formwork panel 8 is placed against the building edge 83 in order to produce the angularly adjacent section of the construction 3 to be manufactured.

With the presented apparatus 1, walls with reinforcement can be produced in any layers and layer thicknesses with different materials. Thus, first an outer shell with concrete in the required exposure class and minimum thickness, in the next layer insulating concrete as core insulation, then the load-bearing shell and finally also an interior plaster can be applied to the walls to be manufactured.

The disclosure specifies an improved apparatus and an improved method which enables the use of hardening building material or building material which is load-bearing by compaction also in other fields of application, e.g. in building construction. For these purposes, a new recess formwork system is also to be specified.

### LIST OF REFERENCE SIGNS

1 apparatus
2 formwork
3 construction
4 spray nozzle
5 spraying direction
6 manipulator
7 carriage
8 formwork panel
9 spray nozzle feed device
10 receptacle
11 darby
12 darby feed device
13 formwork feed device
14 bracket jib
rail system
16 subsoil, ground slab, floor slab
17 protective foil
18 unwinding device
19 first roll (unwinding device)
20 direction of travel
21 separating device
22 upper section
23 lower section
24 sensor device
25 recess formwork system
26 further spray nozzle
27 building material distribution equipment
28 rotating device
29 first rotor element
30 second rotor element
31 first stator element
32 second stator element
33 rotation axis
34 first building material distribution line
35 second building material distribution line
36 first building material supply line
37 second building material supply line
38 recesses
39 formwork boards
40 door formwork
41 window formwork
42 back side
43 contact side
44 spacer
45 structural steel bar
46 reinforcement mat
47 vertical bars
48 horizontal bars
49 crossing point
50 mat level
51 fastening element
52 head
53 shank
54 cross-slot adapter
55 shaft direction
56 undercuts
57 mounting surface
58 covers
59 distribution pole
60 linear drive (spray nozzle feed device)
61 first rotary head (manipulator)
62 second rotary head (manipulator)
63 rewinder
64 sensor carrier
65 second roll (rewinder)
66 through line
67 rotary coupling
68 screwing point
69 socket
70 ring mount
71 vacuum clamping surface
72 perforated plate
73 connecting channels
74 holes
75 vacuum source
76 left edge formwork
77 right edge formwork
78 final formwork
79 upper side of the formwork panel
80 slot in final formwork
81 connection reinforcement
82 sections
83 edge, building edge
84 GPS/GNSS receiver
85 support
86 wheels
87 bridge girder
88 trolley
89 motor slewing ring
90 counterweight
91 linear axis
93 support surfaces
94 winch
95 idler pulley
96 cable pull
97 metal frame
98 vacuum tank
99 conduct
100 valve
101 distributor
102 vacuum hoses
103 hinge
104 clamping rubber
105 linear motor
106 supports
107 sheet metal plates
108 steel baskets
109 central tube
110 reinforcing steels
α angle between edge formwork and formwork panel
β angle between final formwork and formwork panel

1. Apparatus (1) for applying a hardening building material or a building material capable of load-bearing by compaction against a formwork (2) for manufacturing a solid, load-bearing construction (3), for example a wall of a building, having
at least one spray nozzle (4) for spraying the building material in a spraying direction (5) and
a manipulator (6) guiding the at least one spray nozzle (4) and prescribing the spraying direction (5),
characterized in
that the manipulator (6) is mounted on a movable carriage (7), wherein the formwork (2) is formed by a formwork panel (8) which can be moved together with the carriage (7) and is positioned relative to the spray nozzle (4) in the spraying direction (5) and is oriented substantially transversely to the spraying direction (5).

2. Apparatus (1) according to claim 1, characterized by a spray nozzle feed device (9) designed to feed the spray nozzle (4) on the manipulator (6) relative to the carriage (7).

3. Apparatus (1) according to claim 1, characterized by a darby (11) for drawing off the sprayed-on building material, which can be positioned relative to the carriage (7) by means of a darby feed device (12).

4. Apparatus (1) according to claim 1, characterized by a formwork feed device (13), designed for feeding the formwork (2), for example the formwork panel (8), relative to the carriage (7).

5. Apparatus (1) according to claim 1, characterized by a bracket jib (14) connected to the carriage (7), which holds the formwork (2), for example the formwork panel (8), on the movable carriage (7).

6. Apparatus (1) according to claim 5, characterized in that the bracket jib (14) extends over the construction (3) to be manufactured and thus positions the formwork panel (8) and spray nozzles (4) on opposite sides of the construction (3).

7. Apparatus (1) according to claim 5, characterized in that the bracket jib (14) can be moved on two bridge girders (87) via a trolley (88) and has a motor slewing ring (89).

8. Apparatus (1) according to claim 1, characterized in that the carriage (7) can be moved autonomously on a subsoil (16).

9. Apparatus (1) according to claim 1, characterized in that the formwork panel (8) is protected by a protective foil (17), wherein an unwinding device (18) is provided which is designed to unwind the protective foil (17) from a roll (19) and to guide it over the formwork panel (8).

10. Apparatus (1) according to claim 9, characterized in that the unwinding device (18) is designed to unwind the protective foil (17) from the roll (19) against the direction of travel (20) of the carriage (7).

11. Apparatus (1) according to claim 9, characterized in that the formwork panel (8) has a vacuum clamping surface (71) which is designed to clamp the protective foil (17) laminar on the formwork panel (8).

12. Apparatus (1) according to claim 11, characterized in that the vacuum clamping surface (71) is formed by a perforated plate (72) with connecting channels (73) behind it.

13. Apparatus (1) according to claim 1, characterized by a sensor device (24) designed to generate a stop signal by which the spraying of the building material is stopped, provided that the sensor device (24) detects a first limit of a recess formwork system (25) when the carriage moves in the direction of travel (20) along the construction (3) to be manufactured, and/or to generate a start signal by which the spraying of the building material is started and/or continued, provided that the sensor device (24) detects a second limit of the recess formwork system (25) when the carriage moves in the direction of travel (20) along the construction (3) to be manufactured.

14. Apparatus (1) according to claim 1, characterized in that the apparatus (1) comprises at least two spray nozzles (4, 26), wherein the first spray nozzle (4) is designed to spray a first building material and the second spray nozzle (26) is designed to spray a second building material different from the first building material.

15. Apparatus (1) according to claim 1, characterized in that the formwork (2) has at least one edge formwork (76, 77) which is designed to be arranged laterally flush with the formwork panel (8) at an angle (a) to the formwork panel (8).

16. Apparatus (1) according to claim 1, characterized in that the formwork (2) comprises at least one final formwork (78) adapted to be arranged flush with an upper side (79) of the formwork panel (8) at an angle (β) to the formwork panel (8).

17. Apparatus (1) according to claim 16, characterized in that the final formwork (78) can be pivoted by motor relative to the formwork panel (8).

18. Apparatus (1) according to claim 16, characterized in that the final formwork (78) has at least one slot (80) for receiving a connection reinforcement (81).

19. Method for producing a solid, load-bearing construction (3), for example a wall of a building, from a building material which hardens or is stable by compaction, comprising the following steps:
applying the hardening building material against a formwork (2), for example using an apparatus (1) according to claim 1, wherein a manipulator (6) guides at least one spray nozzle (4, 26) for spraying on the building material and prescribes a spraying direction (5) of the spray nozzle (4, 26),
moving a carriage (7), on which the manipulator (6) is mounted, in a direction of travel (20) along the construction (3) to be manufactured on a subsoil (16), and
moving the formwork (2) formed by a formwork panel (8) together with the carriage (7), wherein the formwork panel (8) is positioned relative to the spray nozzle (4) in the spraying direction (5) and is oriented substantially transversely to the spraying direction (5).

20. Method according to claim 19, characterized in that the formwork panel (8) is protected by a protective foil (17), wherein the hardening building material is applied to the formwork panel (8) against the protective foil (17).

21. Method according to claim 20, characterized in that the protective foil (17) is tensioned by a vacuum clamping surface (71) on the formwork panel (8) of the apparatus (1) before application.

22. Method according to claim 19, characterized in that the carriage (7) of the apparatus (1) is moved stepwise along the construction (3) to be manufactured, the construction (3) to be manufactured being produced in sections between the steps of travel of the carriage (7) by means of sections (82) adjoining one another by means of application of the building material, which is hardening or capable of load-bearing by compaction, against the formwork (2) of the apparatus (1).

23. Method according to claim 19, characterized in that the formwork (2) is lifted from the subsoil (16) via a formwork feed device (13) of the apparatus (1) for moving the carriage (7) and is deposited on the subsoil (16) for application of the hardening building material.

24. Method according to claim 19, characterized in that, for producing edges (83) of the construction (3) to be manufactured, at least one edge formwork (76, 77) of the formwork (2) is arranged laterally flush with the formwork panel (8) at an angle (α) to the formwork panel (8).

25. Method according to claim 24, characterized in that the edge formwork (76, 77) is arranged at an acute angle (a) to the formwork panel (8).

26. Method according to claim 19, characterized in that, in order to produce edges (83) of the construction (3) to be manufactured, the apparatus (1) places the formwork panel (8) flush against a previously produced wall (3) so that a right-angled adjoining wall section (82) of the construction (3) to be manufactured can be produced.

27. Method according to claim 19, characterized in that the carriage (7) of the apparatus (1) for producing a solid, load-bearing construction (3), for example a wall of a building, from a building material which hardens or is stable by compaction, is placed on a ground slab (16) and/or floor slab (16) and is moved on this subsoil (16) during the production of the solid, load-bearing construction (3).

28. Recess formwork system (25) for producing recesses (38) for doors and/or windows, having a plurality of formwork boards (39) which form a door and/or window formwork (40, 41), the formwork boards (39) having a back side (42) facing the recess (38) and a contact side (43), wherein the contact side (43) forming the inner side of the frame of the produced recess (38), characterized in that at least one formwork board (39) on the contact side (43) is fastened to at least one structural steel bar (45) of the recess formwork system (25) via spacers (44) of the recess formwork system (25), wherein the structural steel bar (45) is designed to be fastened to a subsoil (16) for positioning the door and/or window formwork (40, 41).
